(19) United States
(12) Patent Application Publication
(10) Pub. No.: US 2021/0351658 A1
(43) Pub. Date: Nov. 11, 2021

(54) ROTOR AND STATOR FOR HIGH SPEED AXIAL FLUX MACHINE

(71) Applicant: MONTANA TECHNOLOGIES, LLC, RONAN, MT (US)

(72) Inventors: Matthew JORE, Ronan, MT (US); Michael Alan KVAM, Polson, MT (US); James Douglas JORE, Polson, MT (US)

(21) Appl. No.: 17/282,490

(22) PCT Filed: Oct. 3, 2019
(86) PCT No.: PCT/US19/54427

§ 371 Date: Apr. 2, 2021

Related U.S. Application Data
(60) Provisional application No. 62/741,047, filed on Oct. 4, 2018.

(51) Int. Cl. H02K 5/20; H02K 21/24; H02K 1/14; H02K 9/19; H02K 9/22; H02K 3/18; H02K 16/04; H02K 15/02; H02K 15/10

(52) U.S. Cl. CPC H02K 5/203; H02K 21/24; H02K 1/14; H02K 9/19; H02K 15/105; H02K 3/18; H02K 16/04; H02K 15/022; H02K 9/227

(57) ABSTRACT

An axial flux permanent magnet high speed machine comprises an inner chamber for a flowable coolant, permanent magnet retention features. Also, a method of assembly with modular components and a number of structures and methods of stator bars and shoes are disclosed.

### CROSS REFERENCE TO RELATED APPLICATIONS

The present invention is a 371 National Phase of pending PCT application no. PCT/US19/54427 filed Oct. 3, 2019, which claims priority to U.S. Provisional Application No. 62/741,047, filed Oct. 4, 2018, which are incorporated herein by reference.

### TECHNICAL FIELD

The present invention is generally related to structures and methods of manufacture of rotors and stators for axial flux permanent magnet machines, such as motors and generators, specifically to traction motors for hybrid and electric vehicles, and even more specifically to high speed motors attached to a gearbox which is adjacent the drive wheel of a hybrid or electric vehicle.

### BACKGROUND

Presently, many types of axial flux permanent magnet (AFPM) motors are used as traction motors for hybrid and electric vehicles. Many designs have been disclosed that use in-wheel direct drive motors. An AFPM motor configured for such a low speed, high torque application is typically too large in diameter and too heavy for integration into the wheel. Other AFPM motors have been designed that utilize the ratio found in the differential gear of existing axles to propel the vehicle. These so-called central motors are higher revolutions per minute (rpm) than direct drive motors, but the central motor combined with the weight of the existing axle with differential gear box is still too heavy. More recent vehicle designs have been proposed which use higher ratio gears located near each drive wheel. A high-speed motor is directly mounted to each gearbox. Such (high speed) motors that rotate at 6000, 8000, and up to 10,000 rpm are generally required (compared to conventional motors, which operate at 1800 and 3600 rpm). Existing AFPM motors are inefficient and mechanically unsound at high speed. Hence, there is a need for an efficient, high-speed, axial flux permanent magnet motor for use in hybrid and electric vehicles.

### SUMMARY OF THE INVENTION

An axial flux permanent magnet (AFPM) machine for high speed applications such as a traction motor for hybrid and electric vehicles. Although a motor is shown and described it is understood that a generator or a motor/generator is equally possible. In fact, it is the nature of hybrid and electric vehicles in that they commonly utilize the AFPM machine as a motor for traction and as a generator for regenerative braking.

These and other aspects of the invention will be apparent from and elucidated with reference to the embodiment(s) described hereinafter.

### BRIEF DESCRIPTION OF THE DRAWINGS

Many aspects of certain embodiments of the invention can be better understood with reference to the following drawings. The components in the drawings are not necessarily to scale, emphasis instead being placed upon clearly illustrating the principles of the present systems and methods. Moreover, in the drawings, like reference numerals designate corresponding parts throughout the several views.

FIG. 1 is a cross-section diagram of a rotor-stator axial flux permanent magnet (AFPM) machine.

FIG. 2 is a cross-section diagram of a stator-rotor-stator AFPM machine.

FIG. 3 is a cross-section diagram of a rotor-stator-rotor AFPM machine.

FIG. 3A is the diagram of the machine in FIG. 3 with an on-board liquid-to-liquid heat exchanger attached to the housing.

FIG. 4 is an isometric view of the exterior of the AFPM machine.

FIG. 5 is a top view of the AFPM machine with motor case removed.

FIG. 6 is an axial cross-section through the stator and rotors of the AFPM machine.

FIG. 7 is a close-up of the cross-section view of FIG. 6.

FIG. 8 is an isometric view of a preformed, continuous coil winding for one phase of the AFPM machine.

FIG. 9 is a three-phase arrangement of the coil of FIG. 8.

FIG. 10 is an isometric view of a stator bar showing laminations and welding pattern.

FIG. 11 is a view of a stamped lamination sheet and a close-up view of the same.

FIG. 11A is a view of a stamped lamination sheet cut into two sheets and a close-up view of the same.

FIG. 12 is a sketch of the folding of a stamped lamination sheet.

FIGS. 13A-13G are isometric views of various forms of bars and shoes for the AFPM stator.

FIG. 14 is an exploded view of a stator of the AFPM machine.

FIG. 14A is a method of assembly for the stator of the AFPM machine.

FIG. 15 is an isometric view of a stator of the AFPM machine and a half bar with a protruding top surface.

FIG. 16 is a cross-section view of the stator of FIG. 15.

FIG. 17 is a cross-section view of a stator of the AFPM machine showing a potting material partially filling some of the inner volume.

FIG. 18 is a cross-section view of electrical connections with rivets within a stator of the AFPM machine.

FIG. 19 is an exploded view of a rotor of the AFPM machine.

FIG. 20 is an illustration of one type of a spiral winding process of a notched sheet to produce the flux return of FIG. 19.

FIG. 21 is an exploded view of a rotor of the AFPM machine.

FIG. 22 is a view of a magnet retention means for a rotor of the AFPM machine.

FIG. 23 is an interior view of a rotor of the AFPM machine.

FIG. 24 is a cross-section view of the rotor of FIG. 23.

FIG. 25 is an analytical model of rotor deflection at 10,000 RPM.

FIG. 26 is a diagram of a path for a flowing coolant in a stator of the AFPM machine.

FIG. 27 is a diagram of a path for a flowing coolant in a stator of the AFPM machine.

FIG. 28 is a cross-section view of a stator with the path of FIG. 27.

FIG. 29 is a diagram of a path for a flowing coolant in a stator of the AFPM machine.

FIG. 30 is a cross-section view of a cooling channel in a stator of the AFPM machine.

FIG. 31 is a diagram of the path for a flowing coolant in FIG. 30.

### DETAILED DESCRIPTION OF EMBODIMENTS

Certain embodiments of an axial flux permanent magnet (AFPM) machine are disclosed. The AFPM machine has a least one iron core stator and one permanent magnet rotor. There are three combinations of stators and rotors that are possible for the AFPM machine. The first combination is rotor-stator. Both the rotor and the stator have a flux return. The stator flux return may be next to a heat exchanger to remove heat from the stator. The second combination is stator-rotor-stator. Both stators have a flux return and the rotor does not. Both stator flux returns may be next to a heat exchanger to remove heat from the stators. The third combination is rotor-stator-rotor. Both rotors have a flux return and the stator does not. There is preferably an inner chamber to allow the circulation of a flowable coolant to remove heat from the stator. Components for one combination may be utilized to form one of the other combinations. For example, magnets and stator bars used in a rotor-stator configuration may be used in forming a rotor-stator-rotor machine of the same dimensions. The preferred combination is rotor-stator-rotor although rotor-stator and stator-rotor-stator combinations may also be used.

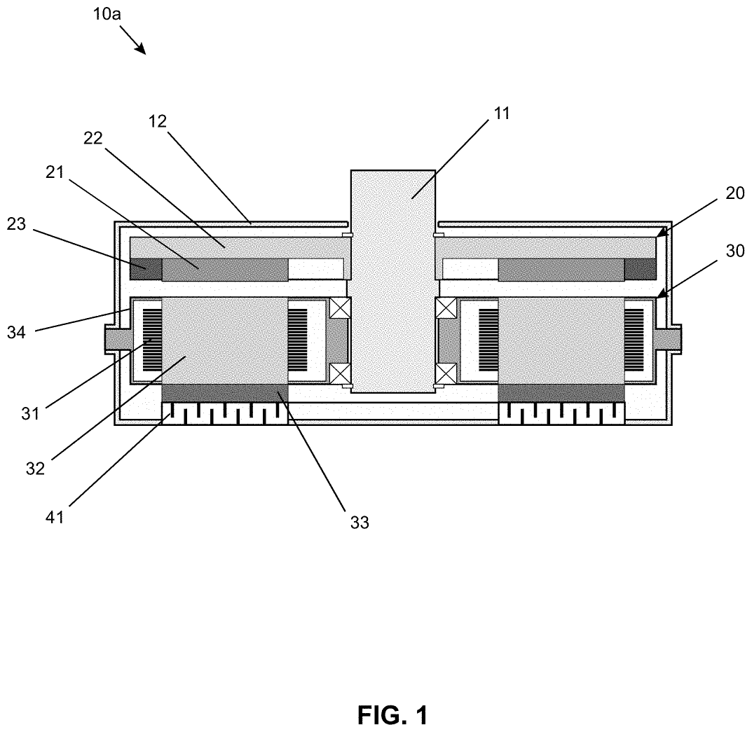

FIGS. 1-3 show three different combinations of rotors and stators for an AFPM machine. FIG. 1 shows an AFPM machine 10a comprising one rotor 20, one stator 30, a shaft 11, and a motor case 12. The rotor 20 comprises a number of permanent magnets 21, a rotor flux return 22, and an outer hoop 23. The flux return 22 is preferably comprised of a magnetically soft material, such as a low carbon steel, and attaches to shaft 11. The hoop 23 is comprised of a high strength material, such as titanium or carbon fiber, and supports magnets 21 against centrifugal force of high speed rotation. The stator 30 comprises a plurality of coils 31, a plurality of bars 32, a stator flux return 33, a stator support 34, and a heat exchanger 41. Coils 31 are preferably comprised of insulated square or rectangular copper wire preformed to be placed around bars 32. Bars 32 are preferably comprised of magnetically soft material such as laminated silicon steel or powdered metal. Stator flux return 33 is comprised of laminated silicon steel or powdered metal. Heat exchanger 41 is comprised of a thermally conductive metal such as aluminum and provides a pathway for a flowable coolant, such as a water/glycol solution, to remove heat from the stator 30.

Note that use of the terms hard materials and soft materials refer to magnetic materials and indicate whether the materials comprise hard magnetic materials or soft magnetic materials, respectively. For instance, hard magnetic materials retain a large portion of magnetism when exposed to a strong magnetic field, such as a permanent magnet. Soft magnetic materials are magnetized by low strength fields and retain little or no magnetism when the field is removed. Iron, low carbon steels, silicon steels, iron-nickel alloys, and iron cobalt are illustrative examples.

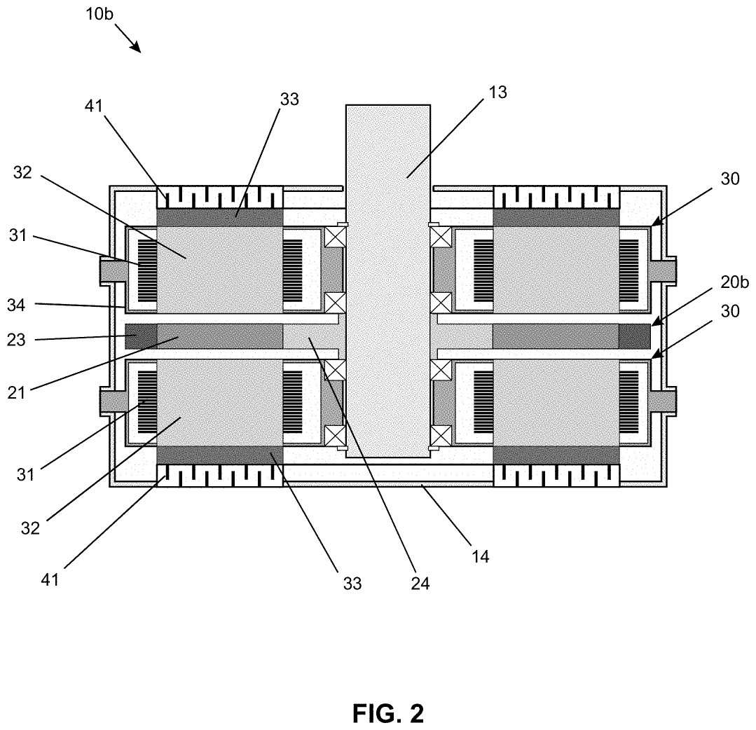

FIG. 2 shows an AFPM machine 10b comprising one rotor 20b, two stators 30, a shaft 13, and a motor case 14. The rotor 20b comprises a number of permanent magnets 21, an outer hoop 23 and a rotor hub 24. Rotor 20b differs from rotor 20 of FIG. 1 in that is does not have a flux return. Hub 24 holds magnets 21 onto shaft 13. The stators 30 each comprise a plurality of coils 31, a plurality of bars 32, a stator flux return 33, a stator support 34, and a pair of heat exchangers 41, each in contact with a stator flux return 33. Heat exchangers 41 preferably are connected to the vehicle cooling system and so utilize the existing water glycol coolant.

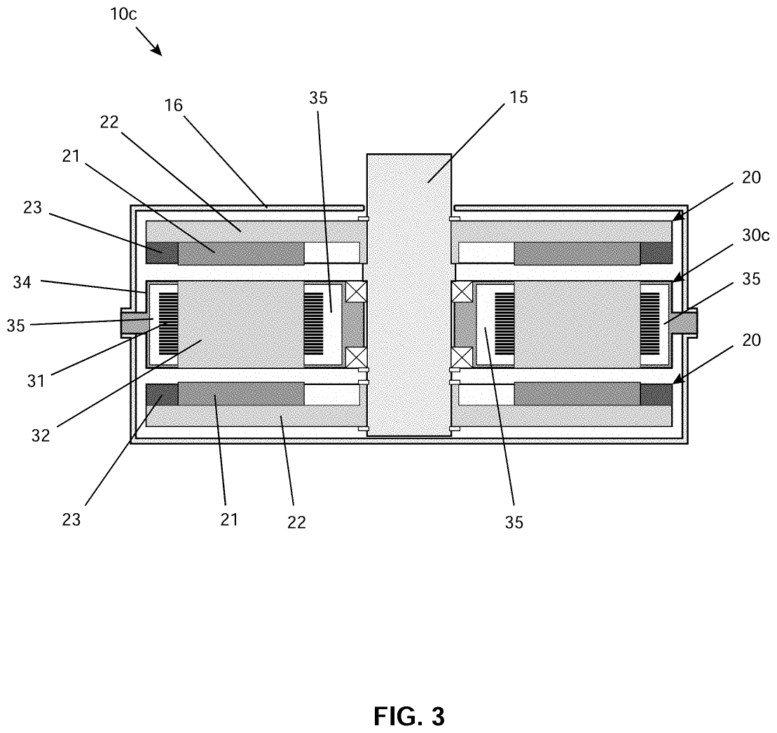

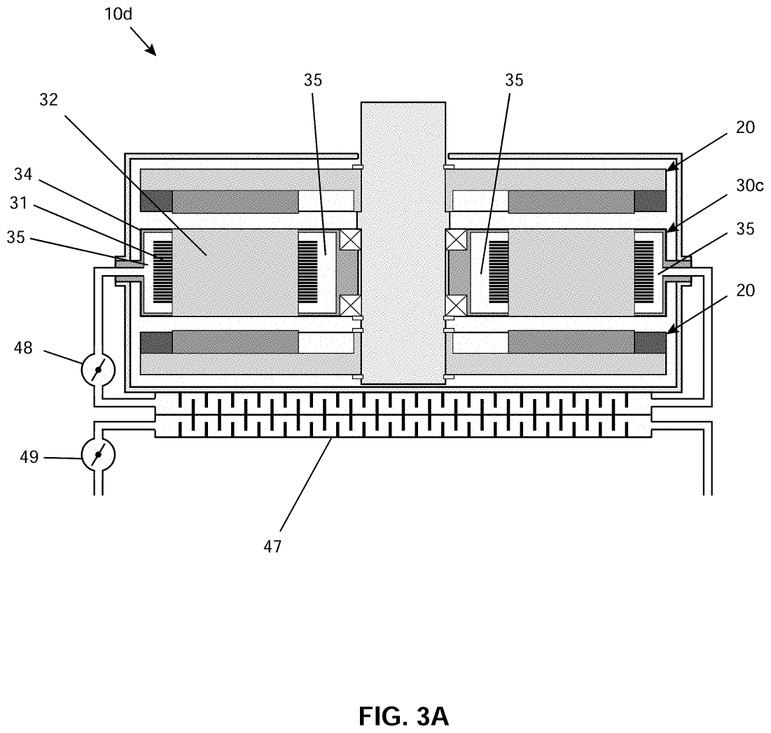

FIG. 3 shows an AFPM machine 10c comprising two rotors 20, one stator 30c, a shaft 15, and a motor case 16. The rotors 20 each comprise a number of permanent magnets 21, a rotor flux return 22, and an outer hoop 23. The stator 30c comprises a plurality of coils 31, a plurality of bars 32, and a stator support 34. Stator 30c differs from stator 30 of FIGS. 1-2 in that stator 30c does not include a flux return or a heat exchanger. Stator support 34 is preferably comprised of a non-conductive material, such as a high-temperature plastic or fiberglass, and encloses a chamber 35 through which a flowable coolant, such as a dielectric oil, is circulated to remove heat from coils 31 and bars 32. FIG. 3A shows an AFPM machine 10d which also comprises a liquid to liquid heat exchanger 47. A pump 48 pushes or pulls the flowable coolant in chamber 35 through one side of heat exchanger 47. A pump 49 pushes or pulls a different flowable coolant such as an ethylene glycol water mixture (EGW) through another side of heat exchanger 47. The heat is removed from stator 30c by the first coolant and then the heat is transferred to the second coolant within the on-board heat exchanger 47. Then the heat is transferred to the environment by the vehicle cooling means, usually a fan cooled radiator (not shown).

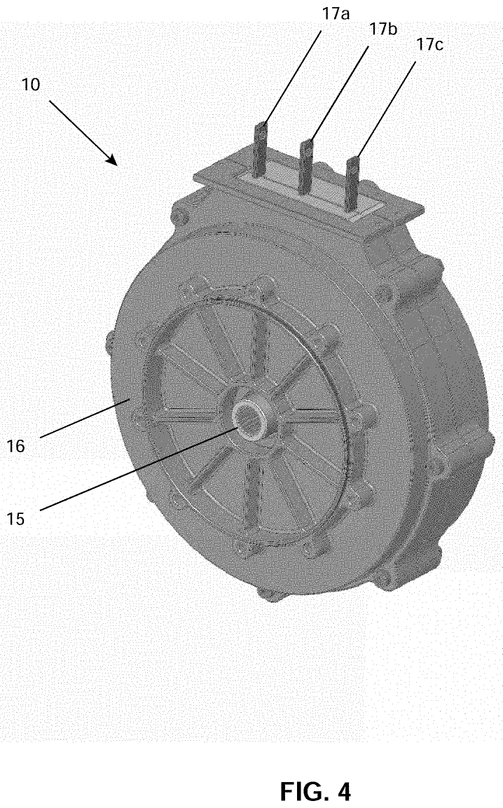

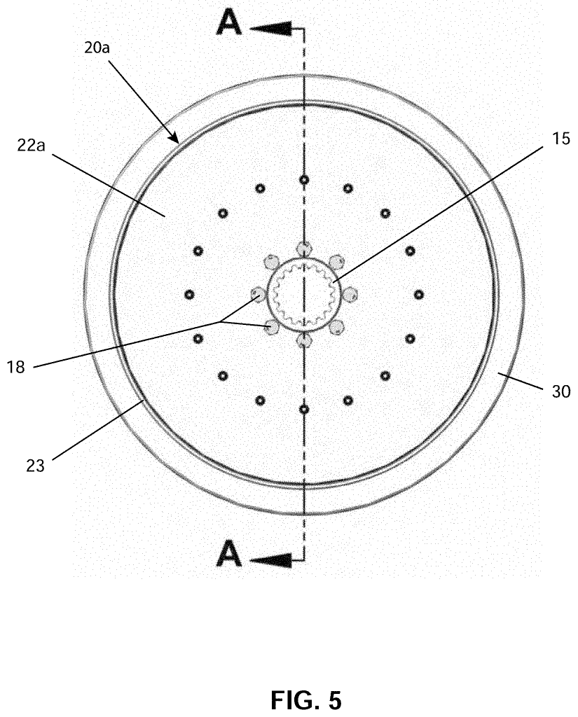

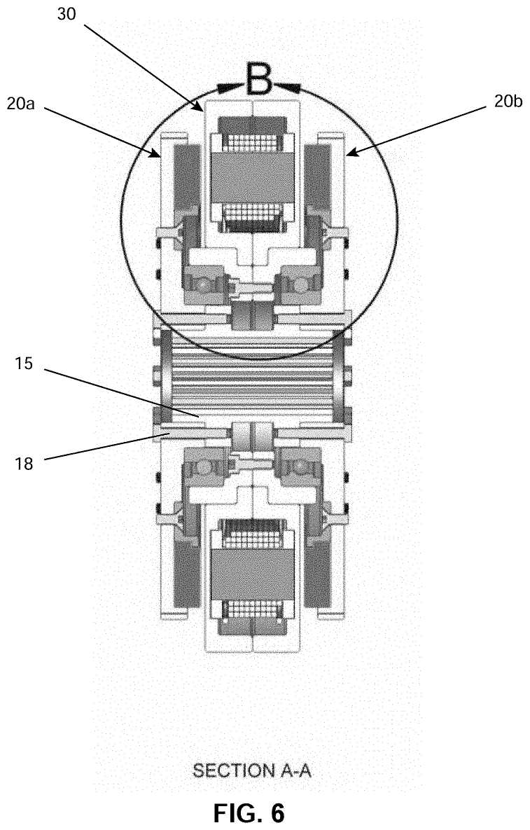

A rotor-stator-rotor embodiment similar to FIG. 3 is shown in FIGS. 4-7. FIG. 4 shows an AFPM machine 10 which comprises an output shaft 15, a motor case 16, and three electrical terminals 17a, 17b, and 17c. In FIG. 5, motor case 16 is not shown, AFPM machine 10 further comprises a rotor 20a, a rotor flux return 22a, shaft 15, a number of rotor mounting bolts 18, a rotor hoop 23, and a stator 30. FIG. 6 shows rotor 20a adjacent one side of stator 30, and a second rotor 20b, adjacent an opposite side of stator 30. Rotors 20a and 20b are fastened to shaft 15 with bolts 18 as shown.

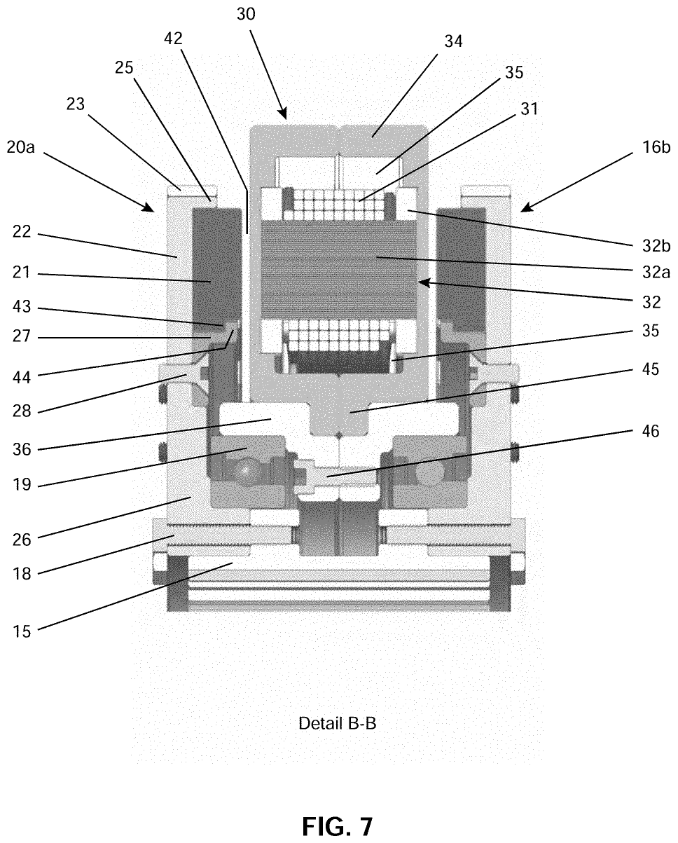

Moving to FIG. 7, the more specific aspects of one embodiment of an AFPM machine will be described. Rotor 20a is comprised of a plurality of permanent magnets 21, a flux return 22, a hoop 23, a hoop support lip 25, a hub 26, a magnet retainer 27, and retainer bolt 28. Flux return 22 is a soft magnetic material such as a low carbon steel. Support lip 25 and rotor hoop 23 provide the centripetal force to keep permanent magnets 21 on rotor 20a when rotated at high speed. Rotor hoop 23 is comprised of a high strength material such as titanium or carbon fiber. In the case where support lip 25 is a soft magnetic material, the axial height of lip 25 is specified to be greater than the axial distance of permanent magnet 21 to any soft magnetic material within stator 30. This is to reduce the amount of flux leakage to rotor 20a. Hub 26 attaches rotor 20a to shaft 11 with rotor mounting bolts 18. A pair of bearings 19 are trapped in a bearing support 36 by hub 26.

FIG. 7 also shows magnet retainer 27 adjacent a radially inward end of permanent magnet 21. Magnet retainer 27 is preferably made of a nonmagnetic material such as aluminum. Rotor 20a is separated axially from stator 30 by an air gap 42. Air gap 42 is preferably a small distance to maximize the flux. Maximizing the flux also increases the attractive force between the permanent magnets 21 and the soft magnetic material within stator 30. In a static condition, the attractive force between the permanent magnet 21 and the flux return 22 is greater that the force attracting magnet 21 to the stator 30. However, bending near lip 25 due to centrifugal force at high speed can cause the magnet to pivot away from flux return 22 and the force between the flux return 22 and magnet 21 is reduced. When the attractive force between magnet 21 and flux return 22 becomes less than the attraction to stator 30 then magnet 21 will leave flux return 22 and contact and damage stator 30. Permanent magnet 21 has a step 43 that receives a flange 44 that is part of magnet retainer 27. Retainer 27 with flange 44 prevents the radial inward end of magnet 21 from being lifted axially away from the flux return 22 due to warping or bending of the rotors during high speed rotation.

Still in FIG. 7, stator 30 is comprised of a plurality of coils 31, a plurality of pole pieces 32, a stator support 34, and a chamber 35. Stator support 34 is preferably made of a rigid plastic or a composite such as fiberglass. Stator pole pieces 32 are generally comprised of a magnetically soft material such as iron or steel. Specifically, pole pieces 32 are preferably comprised of thin laminations of silicon steel to reduce frequency dependent losses, such as eddy current losses, resulting from high speed operation. Stator pole pieces 32 each preferably comprise a bar 32a and shoe 32b. Alternatively, stator pole pieces 32 may be comprised of a fine grain powdered metal or amorphous iron. It is also understood that bar 32a and shoe 32b may be comprised of differing material, such as bar 32a comprising laminated steel and shoe 32b comprising powdered metal. Pole shoe 32b is shown in this embodiment as distinct from bar 32a but integrated bar and shoe configurations are possible from either laminated steel or powdered metal. Stator support 34 has an inner boss 45 around which bearing supports 36 are secured by a number of support bolts 46. Air gap 42 is maintained to an exact distance by carefully controlling the relative dimensions and manufacturing tolerances on hub portion 26 to bearing 19, bearing 19 to bearing support 36, bearing support 36 to inner boss 45. Similar to FIG. 3 above, a coil 31 made of multiple turns of an electrically conductive material such as copper is positioned around the bar 32a. The copper wire of coil 31 is insulated and preferably rectangular or square in cross-section and is preferably preformed to fit around the bar 32a. A contiguous space 35 surrounds the coil 31 and is configured to contain a flowable coolant such as a dielectric oil.

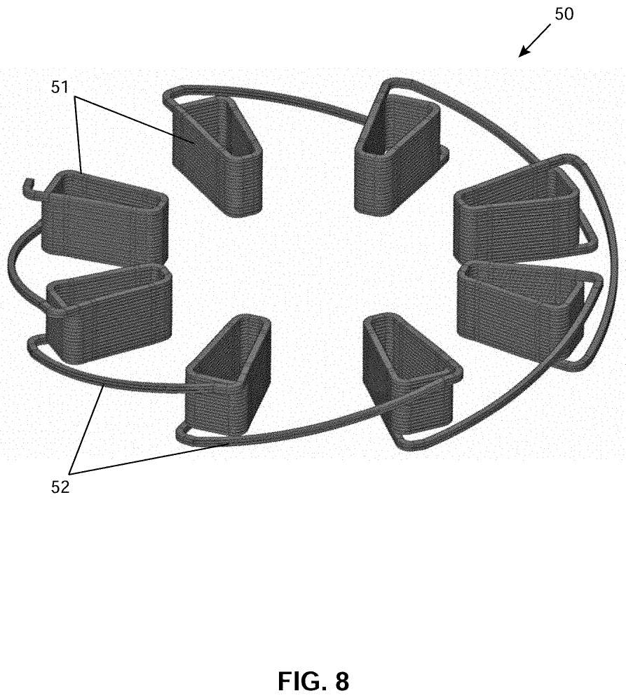

FIG. 8 illustrates an embodiment of a preformed coil array 50 of one of a number of phases for the AFPM machine. Coil array 50 is comprised of plurality of coils 51, the coils 51 connected in series by a plurality of interconnects 52. The coil array 50 is preferably formed as a continuous winding without secondary welds or solder joints.

High speed operation of the AFPM motor results in high electrical frequency in the coils. To achieve high efficiency, it is important to reduce the electrical resistance of the coils. One way to reduce electrical resistance is to increase the size of the copper conductors. However, larger conductors can suffer from skin effect losses which increase with frequency. One way to reduce electrical resistance without overly increasing skin effect losses is to place a number of smaller conductors in parallel. The preformed coil array 50 has two parallel conductors, also called in-hand conductors, wound together to be later placed around an array of stator bars. The number of in-hand conductors shown in FIG. 8 is only one example and it is understood that other numbers of in-hand conductors are possible. The number of coils 51 shown in FIG. 8 is eight but certainly any number of coils continuously wound and connected together in series is possible.

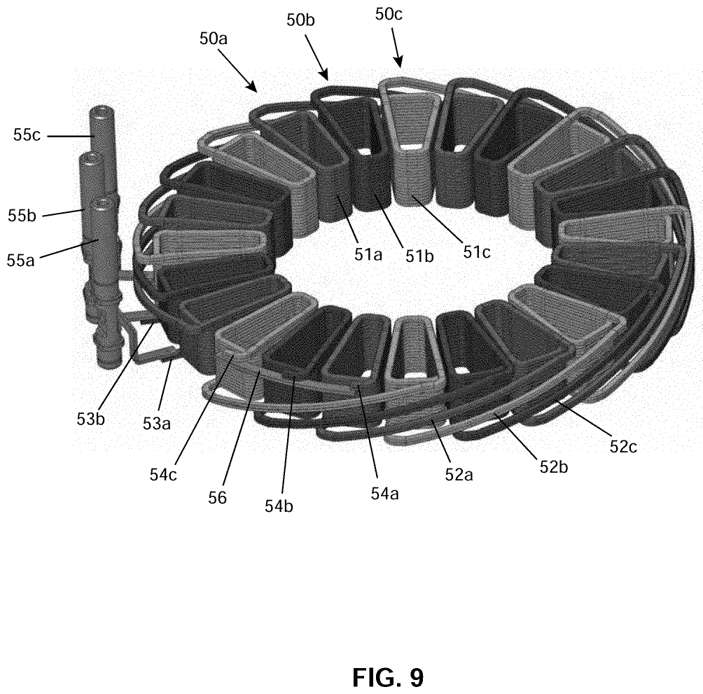

FIG. 9 shows preformed coil arrays 50a, 50b, and 50c in a three-phase arrangement. Each of the coil arrays 50 is further comprised of a first end 53, a second end 54, and a number of stator terminals 55. Also seen in FIG. 9, a wye connector 56 electrically connects coil array second ends 54a, 54b, and 54c. Coil array first ends 53a, 53b, and 53c (hidden) are electrically connected to stator terminals 55a, 55b, and 55c which in turn allow for the connection of the AFPM stator to a three-phase inverter or converter. The preferred circuit is a wye or star connection for the three-phase arrangement although other arrangements are possible, such as a delta connection, or in another embodiment, first ends 53 and second ends 54 each connect to a stator terminal 55. The electrical connections between the first ends 53 and stator terminals 55 and between second ends 54 and wye connector 56 are preferably made by welding or soldering. The entire three phase arrangement with stator terminals and wye connection is given a coating of an electrically insulative, high temperature material such as a motor varnish. The process is also preferably done under a vacuum so that the insulation coating can infiltrate all spaces and completely cover any exposed electrically conductive material of the three-phase circuit.

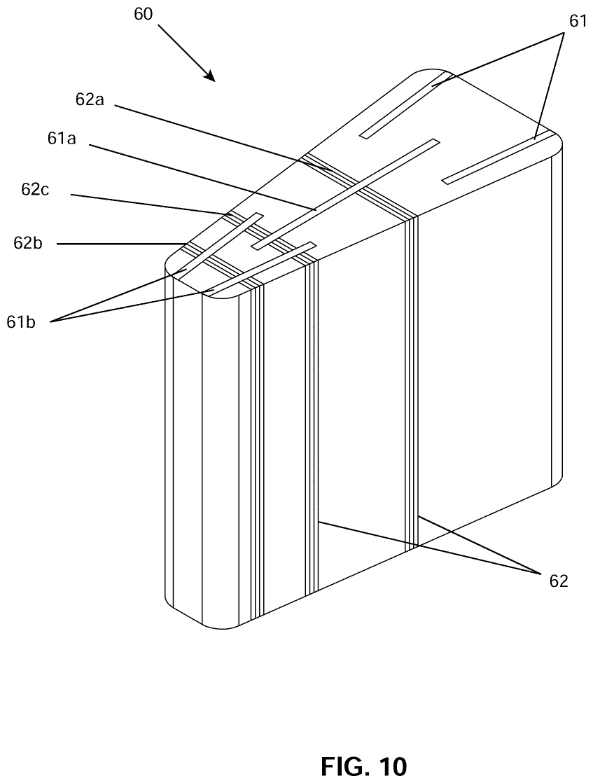

As has been described above, high speed operation of the AFPM motor means a high frequency of electromagnetic excitation losses from some of the motor components. Examples include skin effect losses in the copper conductors, hysteresis and eddy current losses in the ferrous components such as flux returns, stator bars, and pole shoes, eddy current losses in the permanent magnets, and eddy currents losses in any electrically conductive nonferrous material affected by the alternating magnetic field. Skin effect losses can be reduced by replacing large single conductors with several smaller in-hand conductors as previously described. Similarly, eddy current losses can be reduced in laminated stator and rotor cores by using very thin sheets of electrical steel. The laminations are typically welded together in long sections and the individual stator bar shapes are wire cut from the lamination stack. The stator bars are welded across the laminations on the ends nearest each rotor. The welds electrically short the laminations together so it is advantageous to reduce the number of welds required. FIG. 10 illustrates a first embodiment of a stator bar 60 comprising a weld pattern 61 that reduces the eddy currents between laminations 62 enabled by the shorting of the laminations 62 by multiple overlapping welds. There is a weld pattern 61 on the bottom end of stator bar 60 not shown in FIG. 10. Laminations 62a are connected by one weld 61a. Laminations 62b are connected by two welds 61b and a relatively small number of laminations 62c are connected by three welds comprising an overlap of welds 61a and 61b. The degree of overlap is a compromise between the need to mechanically join the laminations together and the goal of reducing the eddy currents between laminations. The number of laminations joined by an overlapping weld is preferably 15-20% of the lamination in bar 60 but other percentages higher or lower are possible. There are, of course, other weld patterns that are possible for securing the laminations one to another such as two welds along each radial edge, or one weld down the middle.

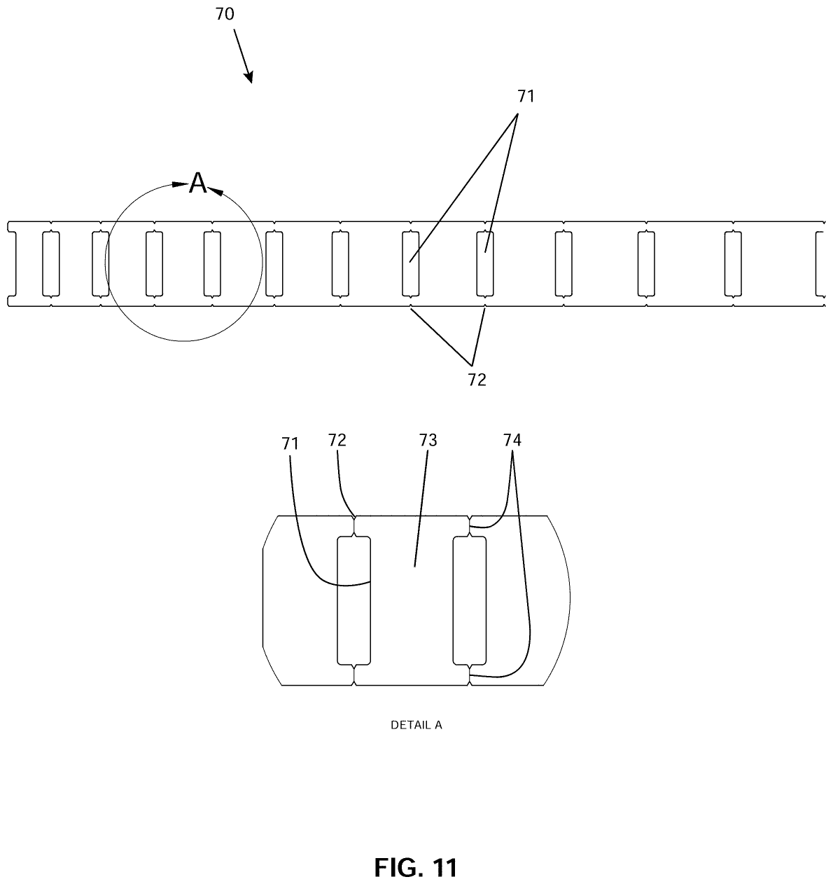

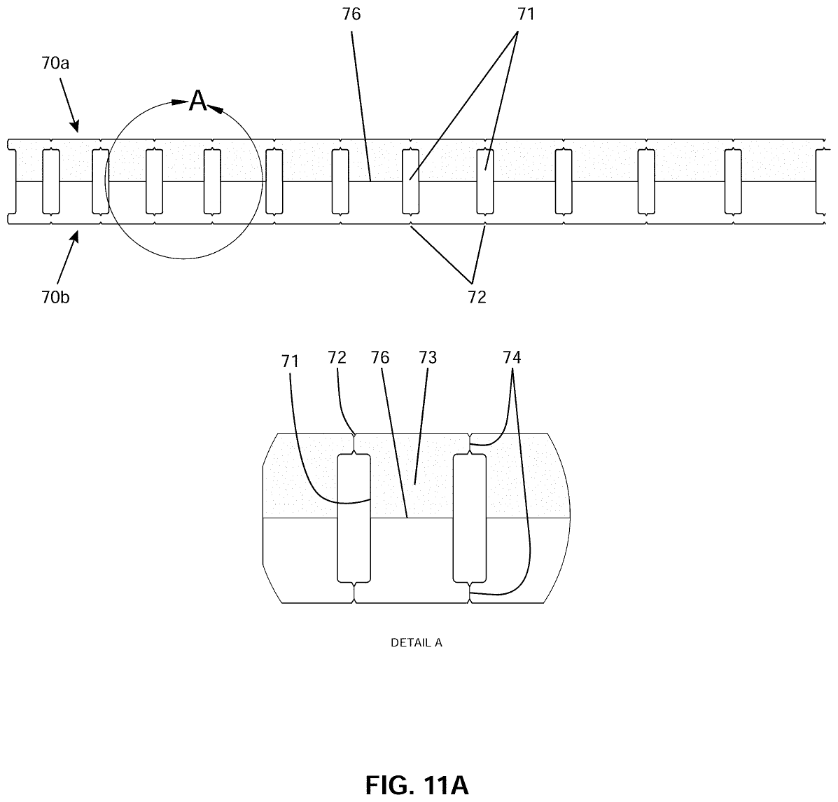

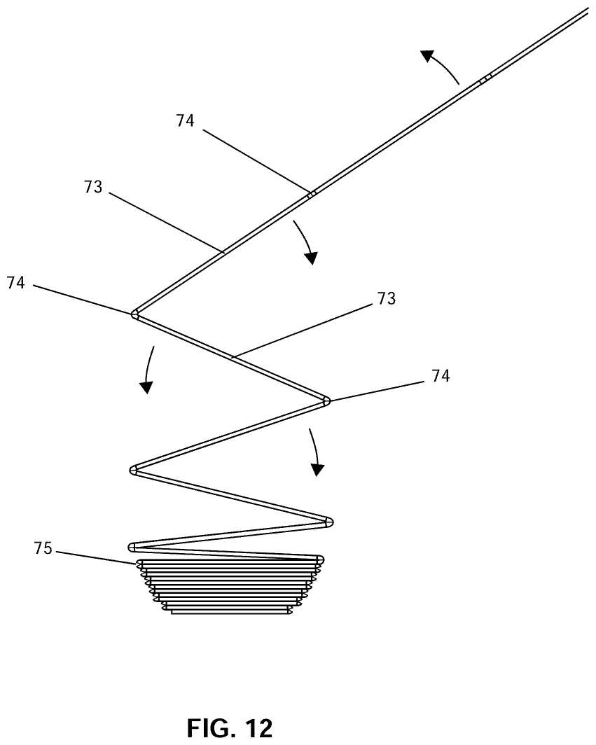

Another method of producing and securing laminated stator bars is shown in FIGS. 11-12. A silicon steel sheet 70 is progressively stamped with a number of cutouts 71 and notches 72. Typically, a computer or a timer controls the advancement of the sheet 70 between stamping operations. The distance between cutouts 71 is varied by the machine to produce the dimensions of each lamination 73 required to create the designed shape of stator bar, or stator bar and shoe, as shown in FIG. 11. Alternatively, FIG. 11A shows sheet 70 split by a cut 76 through the bar portion of laminations 73 to comprise two half sheets 70a and 70b. The notches 72 and cutouts 71 leave a narrow connection 74 between each lamination 73. The narrow connections 74 allow the stamped sheet to be folded back and forth as shown in FIG. 12. The laminations 73 are folded and stacked and welded on both ends of the bar as previously described, or a thin coat of an adhesive, such as an epoxy or motor varnish, is applied between the folds to fix each lamination into position. The final shape of the folded sheet 70 is a bar with a shoe on each end. The final shape for folded sheets 70a and 70b is each forms a half bar with one shoe. Narrow connections 74 preferably crack or break during folding, illustrated by break 75, which benefits the eddy current reduction even more as it increases the electrical resistance between the adjacent laminations.

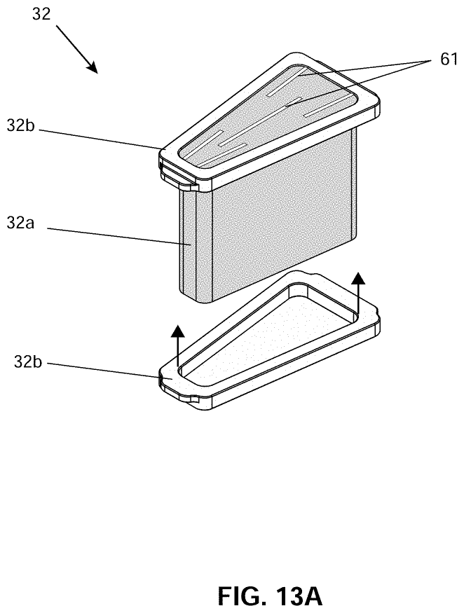

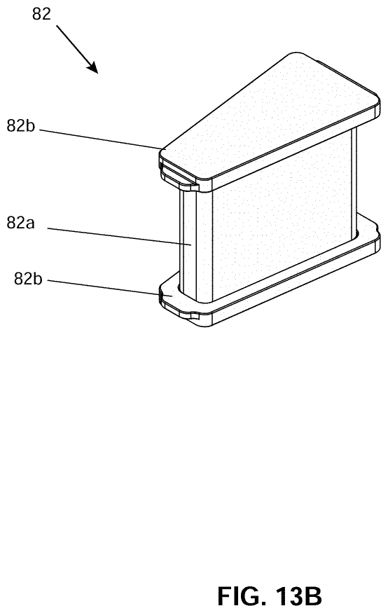

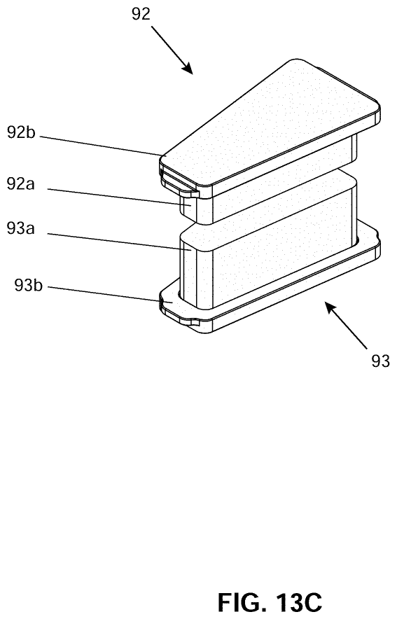

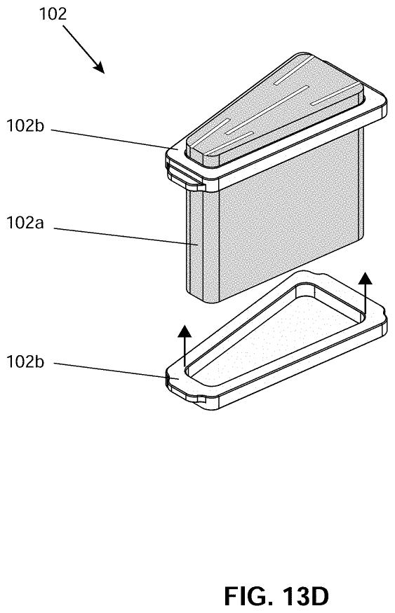

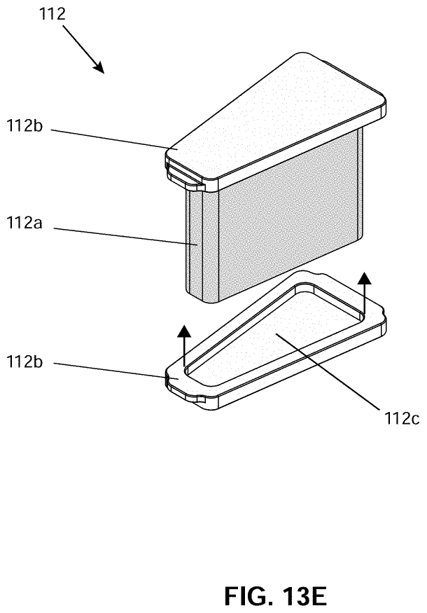

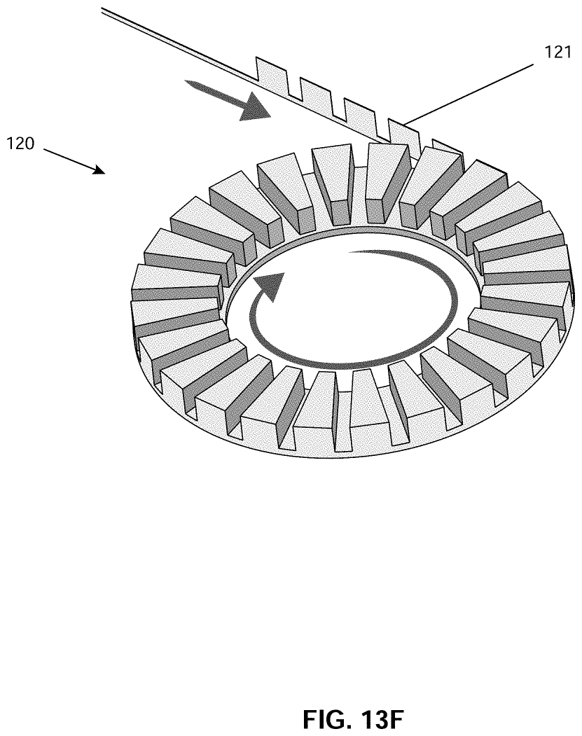

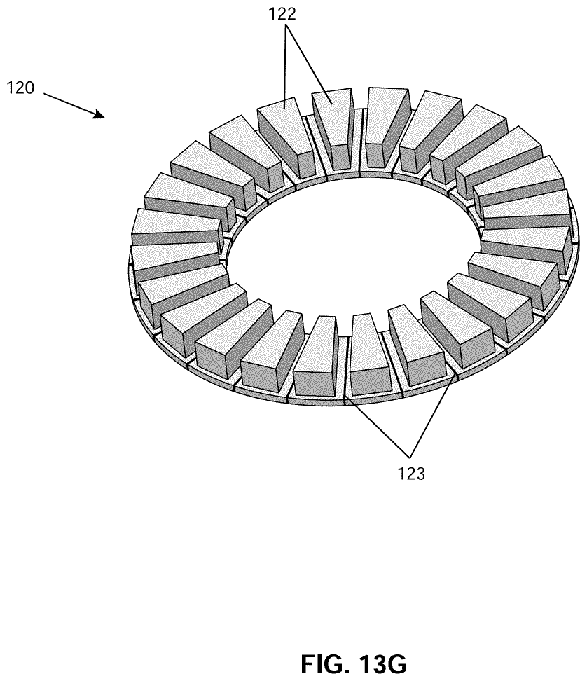

Alternate embodiments for the bars and shoes of the AFPM stator are shown in FIGS. 13A-13G. FIG. 13A further illustrates the embodiment shown in FIG. 7. Stator pole piece 32 is comprised of a bar 32a and two shoes 32b. The shoes 32b are attached to bar 32a after placing a preformed coil (not shown). Bar 32a is comprised of laminated sheets of an electrical steel and also comprises a weld pattern 61. Shoes 32b are comprised of a powdered metal or amorphous iron.

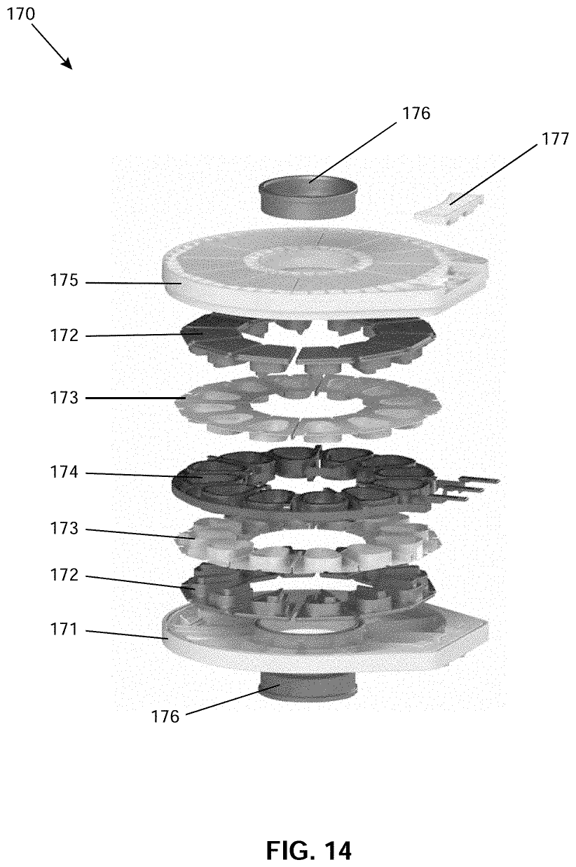

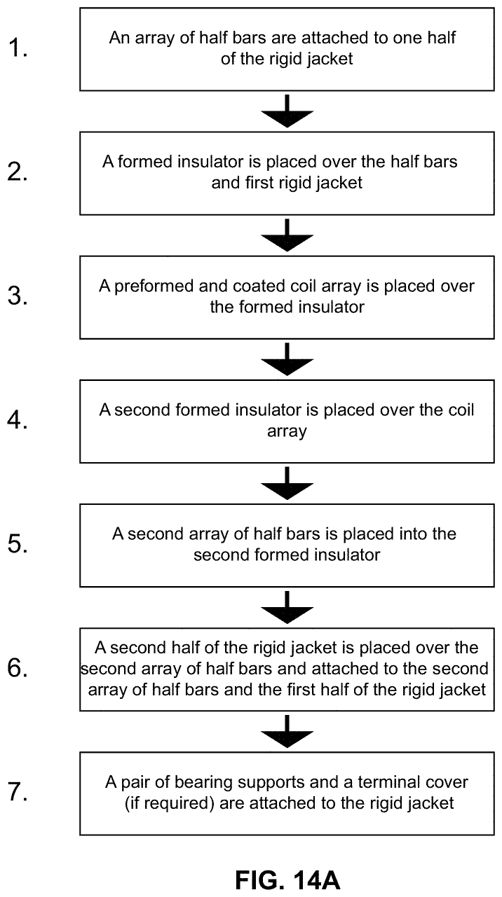

In FIG. 13B, a stator pole piece 82 has a bar 82a and a pair of shoe portions 82b. The bar 82a and shoes 82b are combined and pole piece 82 is formed from a powdered metal. The attached shoe portions 82b make it necessary to wind the coil in place onto pole piece 82. Another embodiment for combining the bar and shoe portions is show in FIG. 13C. A stator pole piece 92 has a half bar 92a and a shoe 92b. A complementary pole piece 93 has a half bar 93a and a shoe 93b. This allows the stator to utilize a preformed coil as described below in FIG. 14.

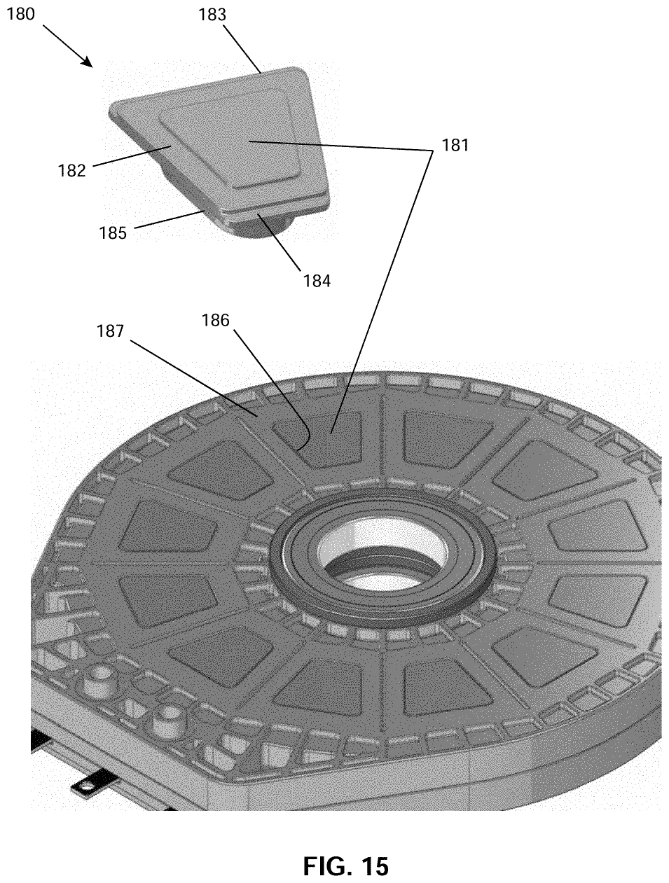

FIG. 13D shows another embodiment of a stator pole piece 102 which is comprised of a bar 102a and a pair of separate pole shoes 102b that are attached to the bar 102a after a preformed coil (not shown) is placed around bar 102a. The shoes 102b are placed so that the end of bar 102a protrudes beyond the surface of shoe 102b as shown. The benefit of this arrangement is described below in FIG. 15.

Another embodiment is shown in FIG. 13E. A stator pole piece 112 is comprised of a bar 112a and two shoes 112b. Shoes 112b have a pocket 112c on one side which mates to one end of bar 112a. Shoes 112b are comprised of powdered metal. Pocket 112c holds the laminations of bar 112a and eliminates the need to weld the ends of bar 112a. In the case where the top of shoe 112b protrudes through the stator cover, also called a stator jacket, the pocket 112c seals against leaks of coolant through gaps in the laminations and protects the laminations of bar 112a from the air which will induce corrosion of the steel laminations.

FIG. 13F illustrates a stator pole piece array 120 that is comprised of a stamped sheet 121 that is spiral wound from an electrical steel. The sheet 121 is coated with an adhesive, such as an epoxy or motor varnish, to attach the layers of sheet 121 together as it is wound. In this way, welding of the bars or shoes is reduced or eliminated. In FIG. 13G, a number of cuts 123 are done to separate pole piece array 120 into a number of pole pieces 122. A means of cutting is used which preserves the shape of the pole pieces and maintains the special properties of the electrical steel, such as water jet, wire EDM, or laser. The embodiment of the finished pole piece 122 shown in FIGS. 13F-13G is of a half bar and one shoe but it is also possible to produce full bars with two shoes in the same manner. It is also preferable in some configurations to have cuts 123 partially separate pole pieces 122 so that the ring shape of the pole piece array is retained. Leaving the array intact makes it easier to automate the assembly of the stator of the AFPM machine.

FIG. 14 illustrates one embodiment of a stator 170 for an AFPM machine. Stator 170 is comprised of a first jacket 171, a plurality of half bars 172, a pair of insulators 173, a coil array 174, and a second jacket 175. The current embodiment also comprises a pair of bearing supports 176 and a terminal cover 177. The jackets 171 and 175 are comprised of a high strength plastic or fiberglass. The coil array 174 is comprised of a number of preformed coils that are connected together in a three-phase arrangement and coated with insulative material prior to the assembly of stator 170. The half bars 172 are preferably comprised of a powdered metal. The half bars can alternatively be comprised of thin sheets of laminated steel or a combination of powdered metal and thin sheets of laminated steel. The insulators 173 are preferably made of an injection-molded high-resistivity plastic. Insulator 173 also is a barrier against mechanical abrasion between the inside of the coils of coil array 174 and surfaces of half bars 172. Insulators 173 can be molded as an array of isolators that are placed over the half bars all at once, or as single isolators place over individual half bars.

The modularity of the components of stator 170 provides for a method of assembly as shown in FIG. 14A. The method comprises; 1. An array of stator half bars such as half bars 172 are attached to a first stator jacket 171 with an adhesive such as a high temperature epoxy. 2. A molded or formed sheet of electrically insulative material such as insulator 173 is placed over half bars 172 with part of insulator 173 also partially covering the inside of jacket 171. 3. Preformed and coated coil array 174 is placed so that an inner opening of each coil slides over a protruding portion of insulator 173 that is covering a protruding portion of each of the half bars 172. 4. A second insulator 173 is placed so that each protruding portion slides into the inner opening of each coil of coil array 174. 5. A second array of half bars is placed so that the protruding portion of each half bar 172 fits inside the portion of the insulator 173 that covers the inner opening of each coil of coil array 174. 6. A rigid jacket 175 is attached to an outer surface of each half bar 172. Jacket 175 is also attached to mating surfaces of jacket 171. 7. Finally a pair of bearing supports such as bearing supports 176 are attached to a center opening of stator 170 and, if necessary, a terminal cover 177 is attached to an outer location of jacket 175. Note that one or more steps may be omitted in some embodiments, or re-arranged in order in some embodiments, or in some embodiments, additional steps may be performed. In some embodiments, steps may be performed concurrently.

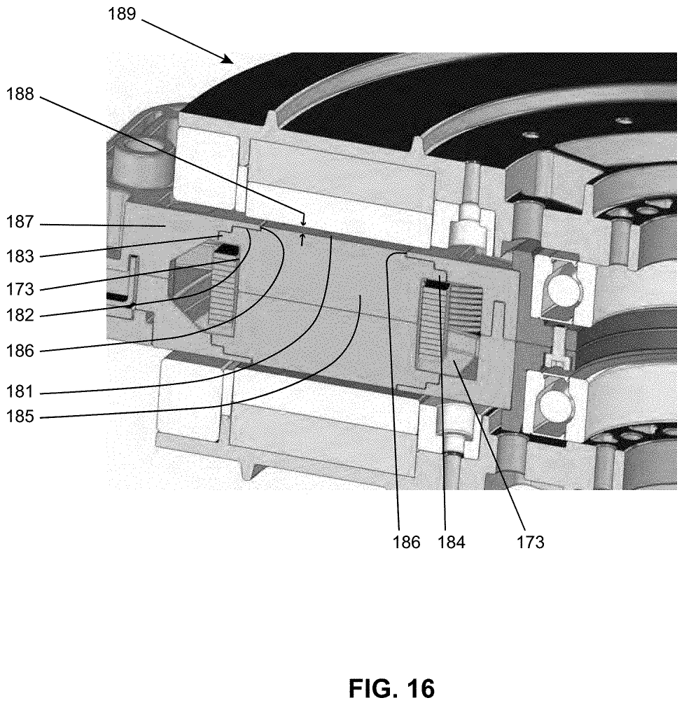

A variation of the embodiment and method described above is illustrated in FIGS. 15-16. A stator half bar 180 has a top surface 181, a stepped surface 182, an outer flange 183, an inner flange 184, and a bar 185. The top surface 181 of half bar 180 protrudes through an opening 186 of the stator support jacket 187. The top surface 181 is preferably coincident with an axial surface of stator jacket 187 that comprises one side of an air gap 188 as shown in FIG. 16. Also shown best in FIG. 16 is insulator 173, which is in position around half bar 180. Stepped surface 182 and flanges 183 and 184 provide a bonding surface with complementary features formed on an inner side of jacket 187. The protrusion of top surface 181 through jacket 187 reduces the air gap 188 with the benefit of increasing the flux within air gap 188. Stepped surface 182 has a greater distance to the permanent magnet rotor 189 and therefore a reduced flux density. The total area of stepped surface 182 can be increased or decreased in order to shape the voltage waveform. For example, if the voltage has a trapezoidal shape then the area of stepped surface 182 is increased to produce a more sinusoidal shape, or vice versa, depending on the desired wave type. As previously shown and described, the bar and shoe arrangement of FIG. 13D is an alternative method of allowing a portion of the stator pole pieces to protrude through the surface of the stator jacket.

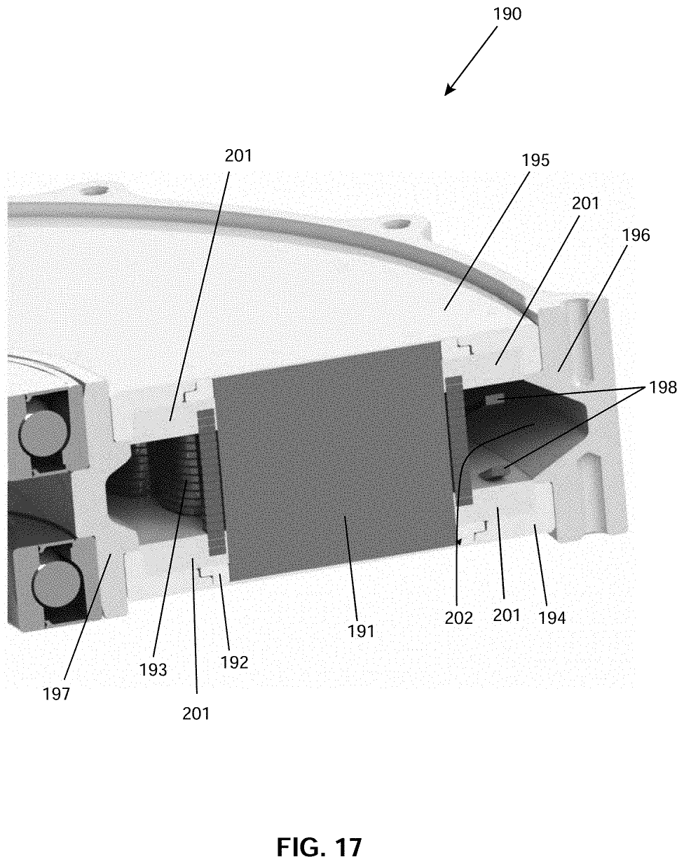

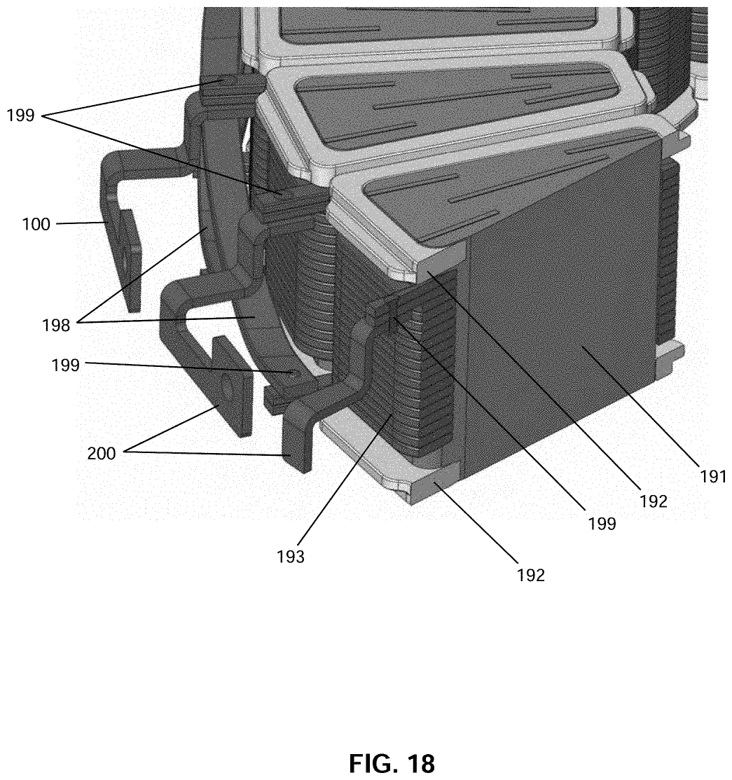

Another embodiment of the AFPM machine improves electrical insulation and reduces vibration of the internal stator components. FIG. 17 shows stator 190 comprising a number of bars 191, a number of shoes 192, a coil array with coils 193, jacket bottom 194, jacket top 195, stator outer support 196, and bearing support 197. A number of coil interconnects 198 connect the coils 193 comprising each phase in series. As best illustrated in FIG. 18, one end of an interconnect 198 is electrically connected to the end of a first coil and the other end is electrically connected to a beginning of a second coil. The interconnects are typically soldered or welded to the ends and beginnings of each coil. The electrical connections may alternatively be secured with a rivet 199 and then soldered, or the connections may be secured by brazing or welding. Similarly, three terminal connections 200 are electrically connected to the beginning coil of each phase. No matter which method is utilized, forming the electrical connections of interconnects 198 to coils 193 as well as the connections of terminal connections 200 to coils 193 leaves a portion of the winding near the connection uninsulated. The proximity of the exposed conductors to other conductive stator components such as shoe 192 requires that these exposed areas should be reinsulated by spraying or brushing on an insulating material such as a varnish, or by wrapping with an insulating cloth or tape. Another method of recoating the exposed conductors is illustrated in FIG. 17 which shows all of the exposed solder or weld points covered by a potting 201. The potting 201 is comprised of a flowable, self-leveling and electrically insulating material that cures to a hard or semi-hard state. The potting process is done in two steps. First, the bars 191, shoes 192, and coils 193 are assembled into the bottom jacket 194. A self-leveling potting material 201 is applied into the bottom jacket 194 until the potting 201 reaches a level which covers the exposed solder joints or welds in the bottom half of the assembly. Then the potting material 201 is cured. Second, the bars 191, shoes 192, coils 193, and jacket bottom 194 on the upper side of the first assembly are fastened to the top jacket 195. The entire assembly is flipped over, and the self-leveling potting material 201 is applied through ports (not shown) in the stator outer support 196 until the exposed connections in the second half of the assembly are covered. Then the potting material 201 is cured. An internal space 202 is not filled with the potting material and preferably contains a flowable cooling material such as dielectric oil. The partial potting as shown and described has an additional benefit in that it reduces vibration of the internal stator components. Another benefit is that the flowable potting material seals the seams between the assembled components where cooling fluid might leak. This is especially true for the embodiment of FIGS. 15-16 where the half bars protrude through the openings in the jackets. The partial potting of stator 190 therefore contributes to the reliability and robustness of the AFPM machine by improving electrical insulation, reducing vibration of stator components, and improving the integrity of the coolant path.

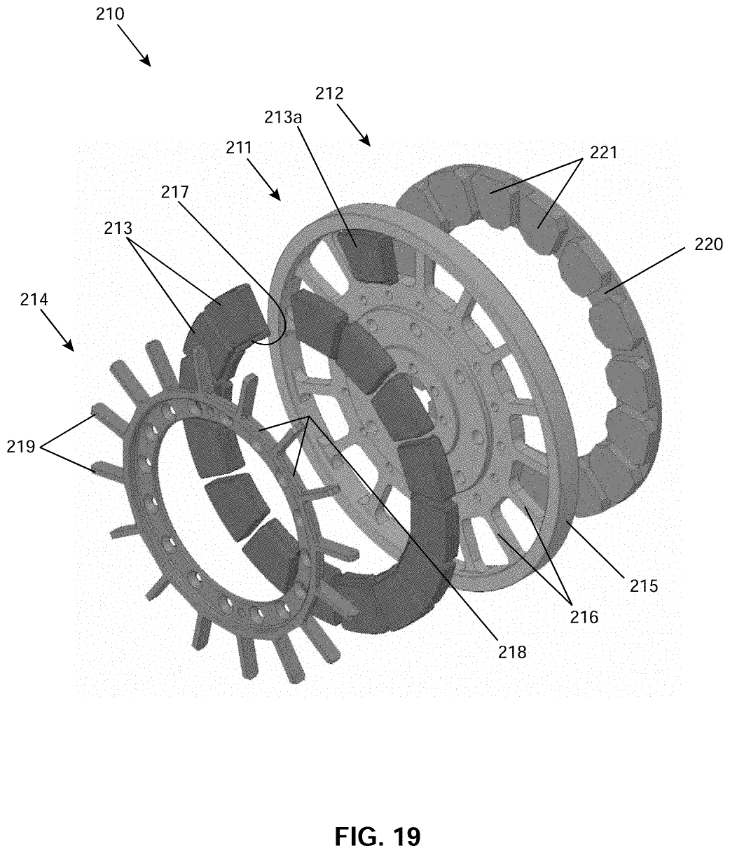

As previously shown and described above, the high-speed operation of the AFPM machine requires improvements in the stator and the permanent magnet rotors. FIG. 7 illustrated one embodiment configured to prevent the permanent magnets from leaving the steel rotor at high speed. In another embodiment of the AFPM machine shown in FIG. 19, rotor assembly 210 comprises rotor 211, flux return 212, magnets 213, magnet retainer 214, and rotor hoop 215. A plurality of spokes 216 mechanically hold rotor hoop 215 to the center hub portion of rotor 211. Rotor hoop 215 holds magnets 213 against the centrifugal force resulting from high speed rotation. Rotor 211 is preferably made from a high strength stainless steel. Rotor hoop 215 may alternatively be comprised of a composite material such as carbon fiber. Each of magnets 213 will be centered over a spoke 216 of rotor 211. A magnet 213a is shown in position on rotor 211. Each magnet 213 has a step 217 that is engaged by flanges 218 of magnet retainer 214 to prevent the magnets from separating from rotor 211 during high speed rotation. Magnet retainer 214 also has a number of radial spacers 219 that fit between each magnet 213 to help keep the magnets in place circumferentially, especially during assembly. Radial spacers 219 also function as a bonding surface for adhesives. The proximity of magnet retainer 214 and especially spacers 219 to the magnetic gap of the AFPM motor requires that it is comprised of a nonferrous, electrically nonconductive material such as plastic or fiberglass. Flux return 212 has a number of radial slots 220 that coincide with the spokes 216 of rotor 211. The radial slots are formed with an axial depth that is equal to or slightly greater than the axial thickness of spokes 216. This is so each magnet 213 securely contacts two back iron portions 221 of flux return 212 on both sides of spoke 216. Flux return 212 is preferably comprised of a lamination of spiral-coiled silicon steel. Slots 220 may be machined, or wire cut after lamination. Flux return 212 may alternatively be comprised a powdered metal with slots 220 molded into the finished piece.

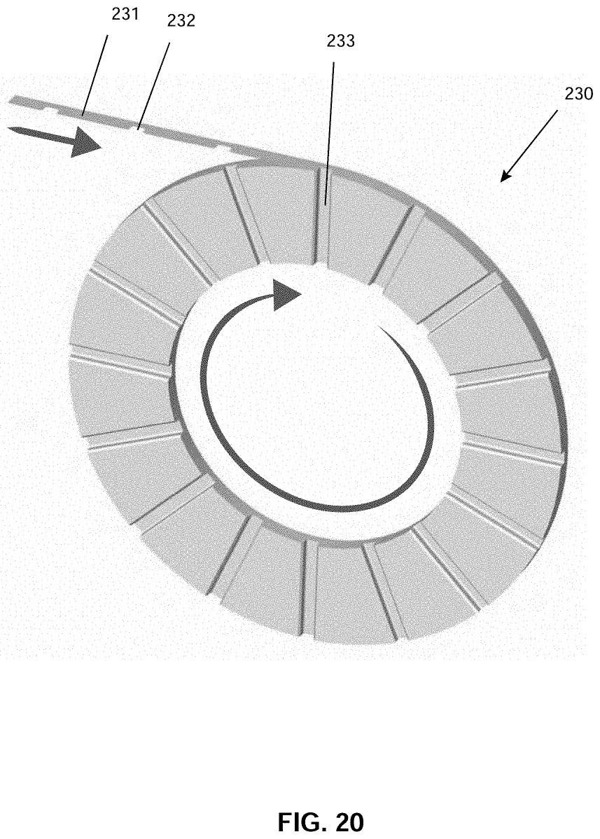

An alternative method of forming slots in a coiled steel flux return is shown in FIG. 20. A flux return 230 is constructed by spirally wrapping a band 231 that is comprised of a suitable material such as a thin non-grain-oriented silicon steel alloy. Band 231 has a number of cutouts 232 that are progressively spaced along the length of band 231 so that as band 231 is wrapped about itself in a spiral fashion, the cutouts 232 line up radially to comprise a number of slots 233. The ends of band 231 are welded to keep the spiral bands of flux return 230 from unwrapping, or alternatively, the bands 231 may be coated with an adhesive, such as an epoxy or motor varnish, to prevent delamination.

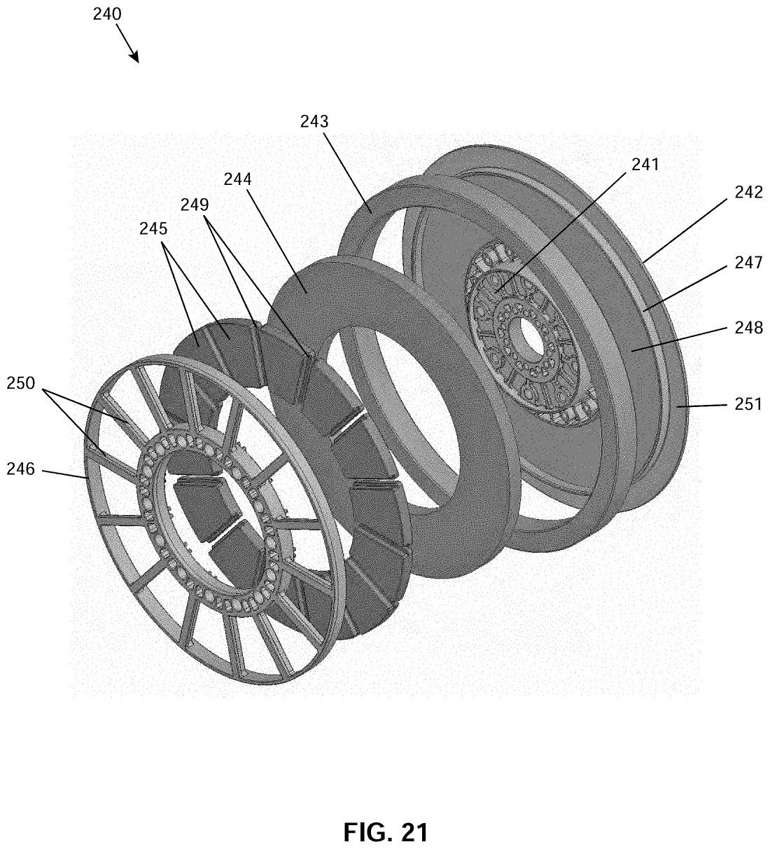

In another embodiment of the AFPM machine shown in FIG. 21, a rotor assembly 240 has a rotor hub 241, a rotor back 242, a rotor hoop 243, a flux return 244, a plurality of magnets 245, and magnet retainer 246. The rotor hub 241 has fastening means to attach to a motor shaft (not shown) and also has fastening means for the attachment of magnet retainer 246. The rotor hub 241 and rotor back 242 are preferably made of a nonferrous material such as aluminum, titanium, plastic, or fiberglass. Alternatively, the rotor hub 241 can be made of a metal, such as steel or aluminum, and the rotor back 242 can be made of another material such as fiberglass. The rotor back 242 has a circumferential rib 247 and an inner gluing surface 248 to attach flux return 244. Flux return 244 is preferably made of a spiral wound silicon steel or a fine-grained, powdered, ferrous metal. Each magnet 245 has a step 249 on each radial edge. Magnet retainer 246 has a number of corresponding flanges 250. Magnets 245 are placed onto the flux return 244 and magnet retainer 246 is attached to rotor hub 241, trapping magnets 245 in place and securing the magnets from lifting off of the flux return by means of the flanges 250 nesting into steps 249 of magnets 245. Rotor hoop 243 is placed over the outer edge of magnet retainer 246 and the circumferential rib 247 and attached to an outer gluing surface 251 of rotor back 242. Rotor hoop 243 is preferably made of a lightweight high-strength material such as carbon fiber to hold the components of rotor assembly 240 in place during high speed rotation.

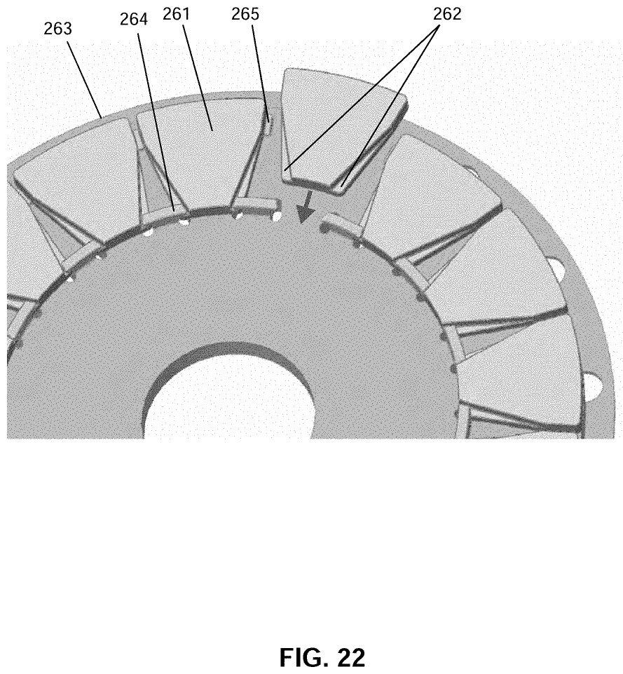

FIG. 22 illustrates another means of retaining the inner portion of the permanent magnets onto a rotor structure. A plurality of magnets 261 each have a pair of steps 262 along each radial edge. Rotor 263 has a plurality of T-shaped retainers 264 integrally formed or machined into rotor 263. Retainers 264 could alternately comprise a number of bolts that insert into threaded holes in rotor 263. Magnets 261 are slid radially inward on the surface of rotor 263 during assembly so that steps 262 engage T-shaped retainers 264 as shown in FIG. 22. Rotor 263 preferably also has outer spacers 265 to maintain the magnet to magnet spacing as each magnet 261 is slid into position. After all magnets 261 have been placed onto rotor 263, a lightweight, high strength hoop (not shown) is placed around the outside of magnets 261 to hold the magnets onto the rotor 263 during high speed rotation.

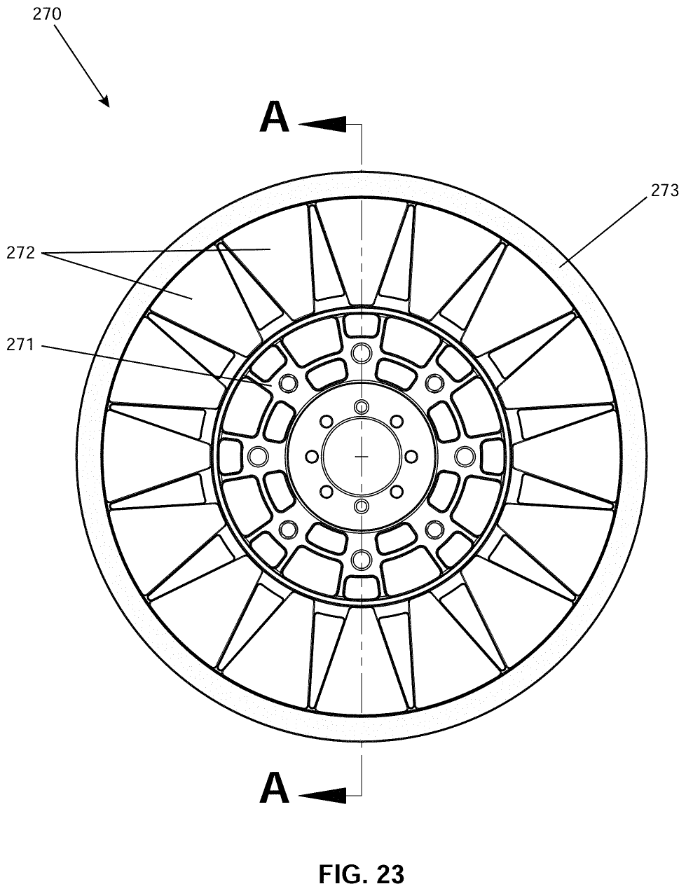

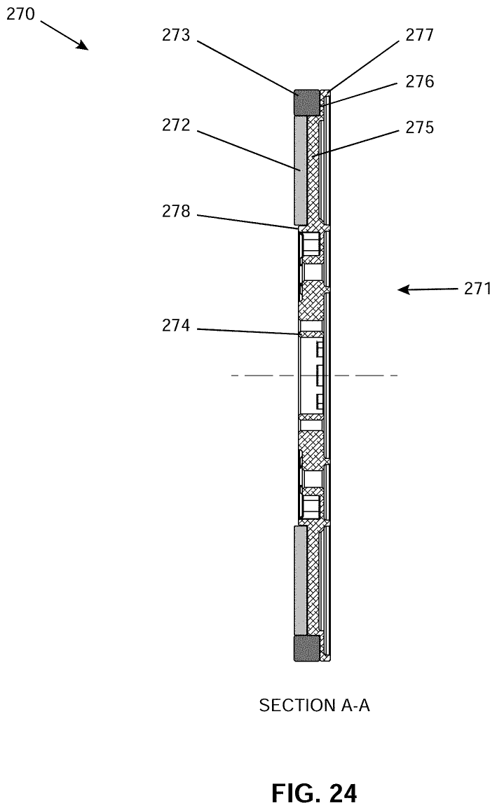

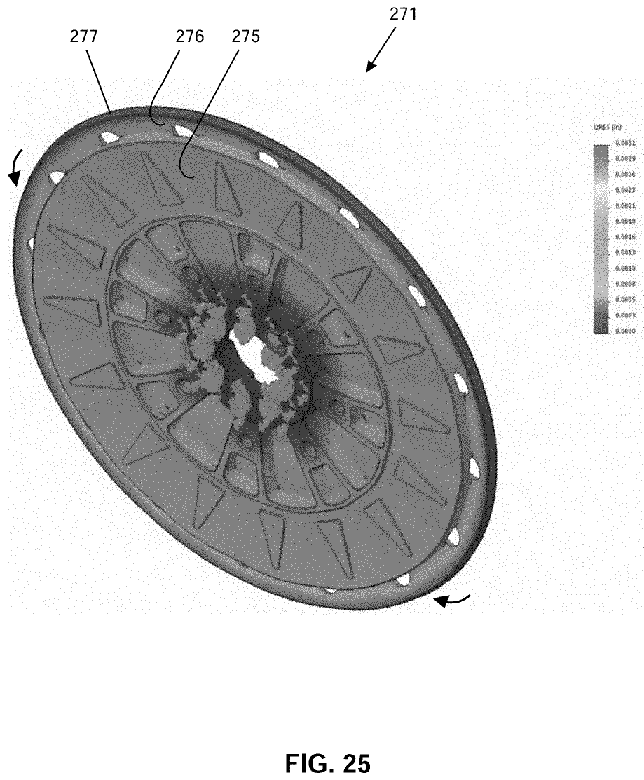

FIGS. 23-25 have another embodiment of the AFPM machine for high speed operation. A rotor assembly 270 is comprised of a rotor 271, a plurality of permanent magnets 272, and a rotor hoop 273. Rotor hoop 273 is preferably comprised of carbon fiber. As best seen in FIG. 24, rotor 271 is further comprised of a hub 274, a flux return 275, a hoop flange 276, and an outer rim 277. Rotor 271 is preferably made of a mild steel. Outer rim 277 provides stiffness to the hoop flange 276. During high speed rotation, centrifugal force on outer rim 277 will cause flange 276 to bend towards rotor hoop 273. The bending assists rotor hoop 273 to retain permanent magnets 272 in position on flux return 275 and keeps the permanent magnets 272 held tightly against an inner retaining lip 278. The required mass of outer rim 277 that is optimum to affect the beneficial bending of flange 276 is confirmed by computer analysis. An example analysis illustrating rim 277 and flange 276 of rotor 271 bending at 10,000 rpm is shown in FIG. 25.

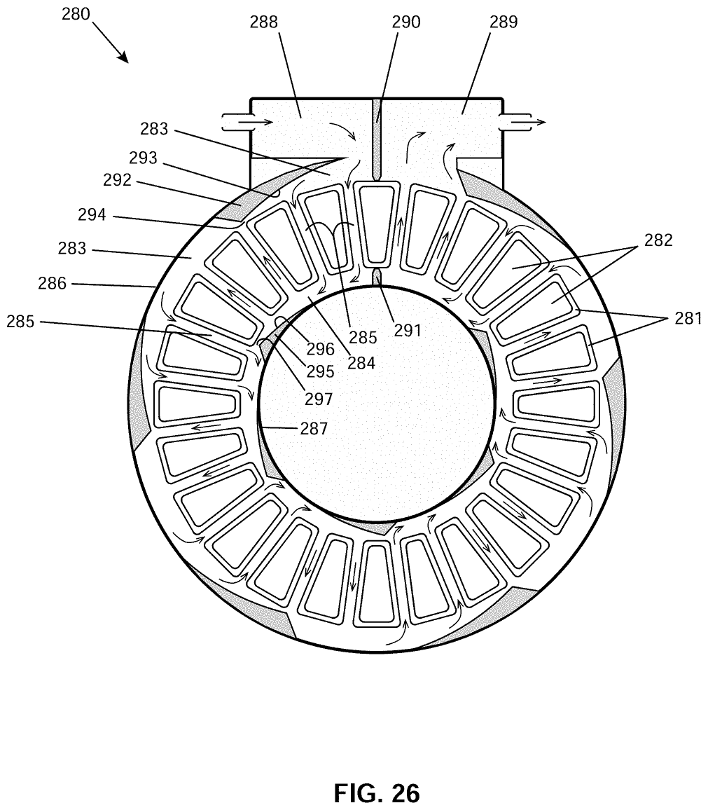

As previously shown and described in FIG. 7, the stator of the AFPM machine comprises a contiguous space 35 through which a flowable coolant is circulated. In FIG. 26, an embodiment of a path of a flowable coolant through stator 280 is shown. A plurality of coils 281 and bars 282 are surrounded by a contiguous space that comprises an outer chamber 283, an inner chamber 284, and a number of intercoil spaces 285. The contiguous space is further comprised of an outer wall 286, and inner wall 287, an inlet 288, and an outlet 289. The inlet and outlet flow paths are divided by an outer separator 290 and an inner separator 291. The flow of coolant is from inlet 288 into the outer chamber 283, then some fraction of the coolant moves radially inward though intercoil spaces 285. An outer baffle 292 has an angled surface 293 that restricts the coolant flow through outer chamber 283. Angled surface 293 further restricts outer chamber 283 until only a small fraction of the coolant may flow through an outer restriction 294. Outer restriction 294 is formed near a radially outward portion of coil 281 so that the coil still benefits from coolant passing over the coil. A larger fraction of the coolant that moves radial inward through intercoil spaces 285 is collected and flows through inner chamber 284. As coolant flows along inner chamber 284, some fraction of the coolant passes radially outward through intercoil spaces 285. An inner baffle 295 has an angled surface 296 that restricts coolant flow through inner chamber 284. Angled surface 296 further restricts inner chamber 284 until only a small fraction of the coolant may flow through an inner restriction 297. Inner restriction 297 is formed near a radially inward portion of coil 281 so that the coil still benefits from coolant passing over the coil. Outer baffles 292 and inner baffles 295 are positioned to create zones of alternating high pressure and low pressure so that coolant flows radially inward through intercoil spaces 285 from a high-pressure zone in outer chamber 283 to a low-pressure zone in inner chamber 284. And then the coolant flow is radially outward through intercoil spaces 285 from a high-pressure zone of inner chamber 284 to a low-pressure zone of outer chamber 283. The coolant flows inward and outward in this manner through the remainder of stator 280 until the coolant reaches outlet 289. The baffles 292 and 295 are preferably made of a chemical and thermal resistant plastic. The baffles 292 and 295 are fastened to outer wall 286 and inner wall 287 by an adhesive or with a fastener, such as a bolt (not shown). Alternatively, the shape of baffles 292 and 295 made be molded or machined as a part of the walls 286 and 287. The invention has the benefit of directing the coolant to flow over all of the surfaces of the coils 281 without creating hotspots that are caused by solid barriers from the walls to the coils where at least a portion of the coil is covered by the barrier and not reached by the coolant flow. It is also preferred that outer separator 290 and inner separator 291 have a small gap between the separator and the coil so that a small amount of coolant is able to flow across the surface of the coil. Alternatively, the portions of separators 290 and 291 that contact the coil are narrow so that the smallest area possible is covered by the separator and shielded from flowing coolant.

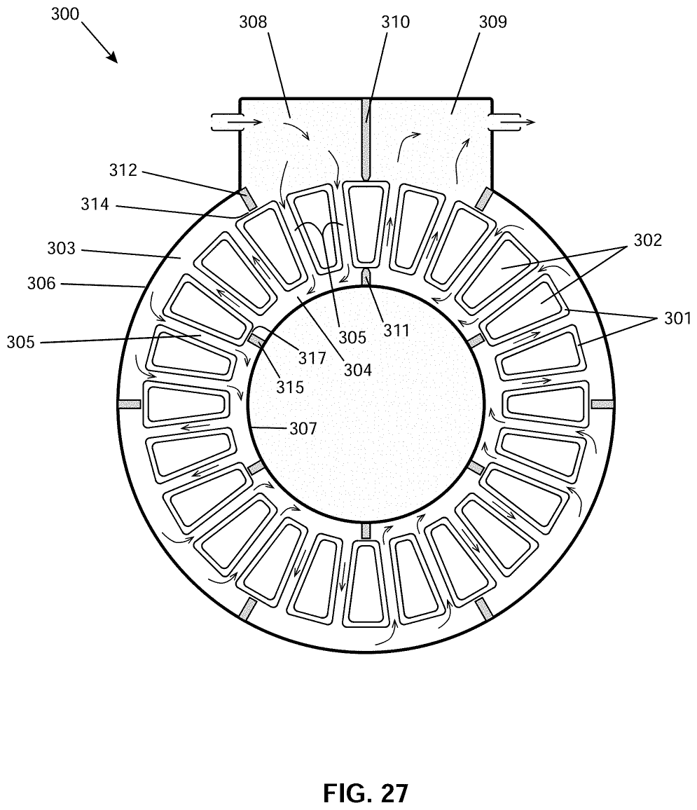

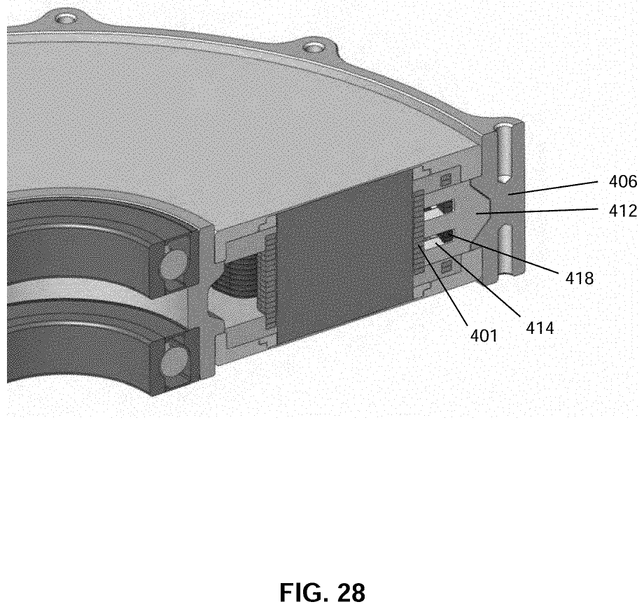

Another embodiment of a stator for an AFPM machine is shown in FIGS. 27 and 28. A stator 300 comprises a plurality of coils 301 around bars 302 in circumferential arrangement as shown and described in previous embodiments. Stator 300 further comprises an outer chamber 303, an inner chamber 304, a plurality of intercoil spaces 305, an outer wall 306, and an inner wall 307 which define a contiguous space within stator 300 through which a flowable coolant is circulated in order to remove heat produced in coils 301 and bars 302 during high speed operation of the AFPM machine. Stator 300 has inlet 308 and an outlet 309 divided by separators 310 and 311. Separators 310 and 311 preferably have a small gap between the end of the separator and the coil 301 where some coolant is allowed to flow next to coil 301. Alternatively, the end of separators 310 and 311 which contact the coil 301 are made to be as narrow as possible to keep the area of the coil 301 that is shielded from flowing coolant as small as possible. The coolant enters inlet 308 and flows in a generally circular pattern around coils 301 and bars 302 to outlet 309. As the coolant flows around from inlet to outlet, it is directed to flow radially inward and radially outward through intercoil spaces 305. A number of outer diverters 312 are located in outer chamber 303 to cause the majority of the coolant to flow radially inward through intercoil spaces 305. The outer diverters 312 are fastened to outer wall 306 by an adhesive or bolts. A radially inward end of outer diverter 312 preferably forms a small bypass gap 314 that allows some portion of the coolant to pass along the coil 301. The coolant flowing radially inward through intercoil spaces 305 moves along inner chamber 304. A number of inner diverters 315 that are fastened to inner wall 307 cause the majority of the coolant to flow radially outward through intercoil spaces 305. A radially outward end of inner diverter 315 preferably forms a small bypass gap 317 that allows some portion of the coolant to pass along the coil 301. The coolant flowing radially outward through intercoil spaces 305 collects and flows through outer chamber 303 until another outer diverter 312 causes the coolant to flow radially inward through the next intercoil spaces 305. The pattern repeats until the coolant reaches outlet 309. The diverters with the bypass gaps allow the entire outer surface of coils 301 to be cooled by flowable coolant.

FIG. 28 illustrates one embodiment of an outer diverter 412 attached to outer wall 406. A number of bypass gaps 414 penetrate the diverter 412 to allow a small portion of a flowable coolant to pass along coil 401. Bypass gaps 414 also create a passage for a number of coil interconnects 418.

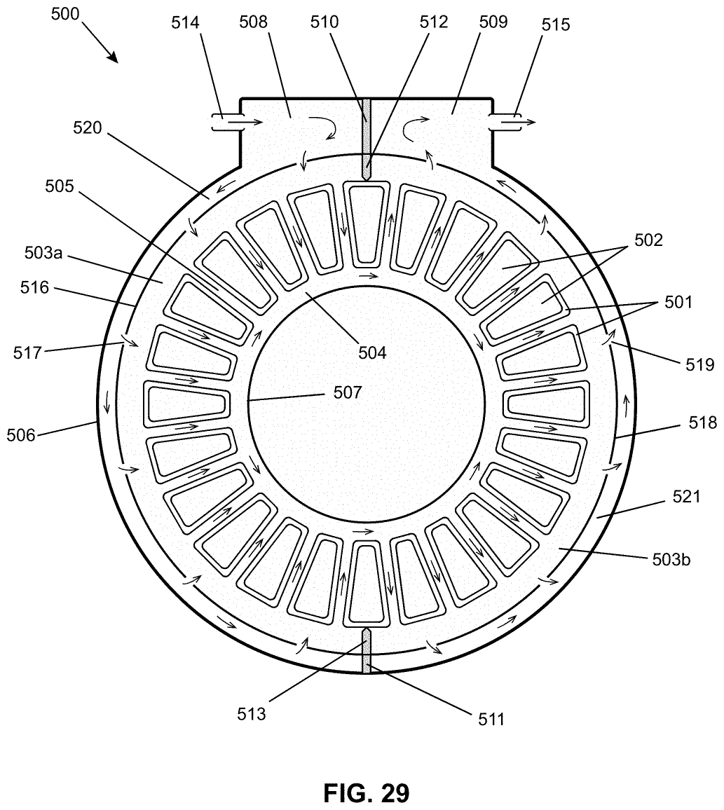

FIG. 29 illustrates one embodiment of a stator for an AFPM machine in which a stator 500 comprises a plurality of coils 501, a plurality of bars 502, an outer chamber 503 (e.g., 503a, 503b), an inner chamber 504, a plurality of intercoil spaces 505, an outer wall 506, and an inner wall 507. Stator 500 further comprises an inlet collector 508, an outlet collector 509, a first separator 510, a second separator 511, an inlet manifold 520, and an outlet manifold 521. Inlet manifold 520 is comprised of a portion of outer wall 506, a manifold wall 516, and a plurality of apertures 517. Outlet manifold 521 is comprised of a portion of outer wall 506, a manifold wall 518, and a plurality of apertures 519. The flowable coolant enters stator 500 through an inlet 514, the coolant fills inlet collector 508 and then into inlet manifold 520. Pressure in the manifold forces the coolant through the relatively small apertures 517 so that the coolant enters outer chamber 503 with some velocity and turbulence. Outer chamber 503 is divided into an inlet side 503a and an outlet side 503b by an outer diverter 512 and another outer diverter 513. Outer diverters 512 and 513 are positioned as shown in FIG. 29 so that substantially all of the coolant flow passing through the inlet manifold 520 and into outer chamber 503a is directed to pass radially inward through one half of intercoil spaces 505. Diverters 512 and 513 allow a small portion the coolant to pass along the coil which they are adjacent to prevent the creation of a hot spot. The coolant moves through inner chamber 504 and passes radially outward through the other half of the intercoil spaces 505 and then into outer chamber 503b. The coolant is then forced through apertures 519 into outlet manifold 520 and fills outlet collector 509 and the coolant moves out of stator 500 through outlet 515. One benefit of this embodiment is that the cooling path is low pressure, high volume compared to other paths due mainly to the relatively high number of parallel coolant paths through the intercoil spaces 505. The apertures 517 and 519 and the inlet 514 and outlet 515 are the main restrictions to coolant flow in this embodiment. The inlet and outlet are preferably greater than or equal to the cross-section area of the manifolds. The cross-section area of the inlet apertures 517 together are less than the cross-section area of the inlet manifold 520, preferably 90-95% less total cross-section area. The total cross-section area of outlet apertures 519 is also less than the cross-section area of the outlet manifold 521 to ensure an equal flow distribution through intercoil spaces 505. The number of inlet apertures 517 is shown in FIG. 29 as six equally-spaced apertures but other numbers of apertures with equal or unequal spacings are possible. Likewise, other numbers and spacings of the outlet apertures 519 are also possible.

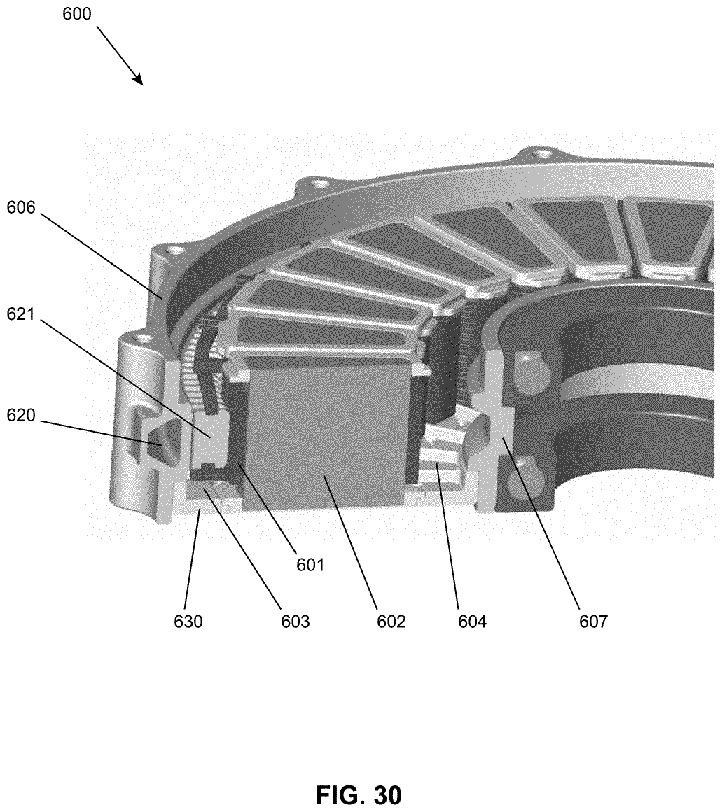

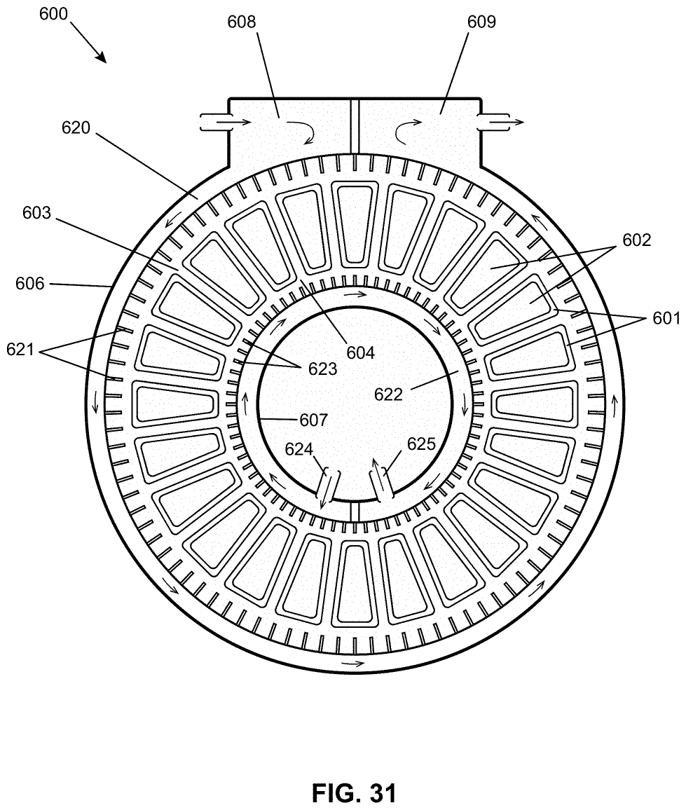

FIGS. 30 and 31 illustrate another embodiment of a stator for an AFPM machine. In FIG. 30, a stator 600 comprises a plurality of coils 601, a plurality of bars 602, an outer wall 606, and an inner wall 607. Stator 600 further comprises jackets 630 (upper jacket hidden) that are attached to outer wall 606 and inner wall 607 to create an outer chamber 603 and an inner chamber 604 which contains a flowable coolant such as a dielectric oil. Outer wall 606 also outer channel 620 is not contiguous with outer chamber 603. A plurality of cooling fins 621 are formed along the inner wall of channel 620 to transfer heat from the coolant contained in chambers 603 and 604 to a different coolant such as water or a water/glycol mixture in flowing through channel 620. As shown in FIG. 31, stator 600 may also comprise an inner channel 622 with cooling fins 623 formed along an outer wall of channel 622. The coolant flowing in outer channel 620 has an inlet 608 and an outlet 609 which may either be in series or in parallel with an inlet 624 and an outlet 625 of channel 622. The coolant within chambers 603 and 604 self-circulates by convection as the coils 601 and bars 602 give up heat to the coolant and as the coolant gives up heat to cooling fins 621 and 623. The AFPM machine with stator 600 is more easily utilized in vehicles that use water or water/glycol heat exchangers.

While the illustrations and narrative disclosed herein are specific to axial gap stator architectures, a similar configuration of the AFPM machine and methods and interconnections of like-phase conductors may be utilized for linear motors and/or radial motors and such alternate architectures of machines is contemplated by the structure and methods illustrated explicitly in detail by the axial gap machine.

The illustration and narrative disclosed herein of the AFPM machine is specific to a circuit architecture that provides for both polarities of terminals for each phase, e.g., a six terminal, three-phase stator. And, the illustrated AFPM stator is specific to a three terminal, Star [Wye], three-phase stator. However, these examples are illustrative, and hence the invention is not limited to such specific illustrated embodiments. Instead, any number of phases, poles, turns and phase terminal arrangements can be derived by the structure and methods of the invention, including independent polarity terminals per phase, or phases connected in series, such as Star [Wye] or Delta as may be suitable for the chosen torque and speed characteristics and controllers for operation of the motor and/or generator.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the present technology can include a variety of combinations and/or integrations of the embodiments described herein. Although the systems have been described with reference to the example embodiments illustrated in the attached figures, it is noted that equivalents may be employed, and substitutions made herein without departing from the scope of the disclosure as protected by the following claims.

1. An axial flux permanent magnet machine comprising:
at least one permanent magnet rotor; and
at least one stator, the stator comprising a number of electrical phases, each phase having a number of coils around a same number of pole pieces comprised of a magnetically soft material, the pole pieces attached to a pair of non-metal covers, the non-metal covers enclosing a chamber for a flowable coolant.

2. The machine of claim 1, wherein the permanent magnet rotor comprises a number of permanent magnet poles that are attached to a flux return, the flux return comprising a magnetically soft material.

3. The machine of claim 2, wherein the flux return is comprised of low carbon steel.

4. The machine of claim 2, wherein the flux return is comprised of a spiral wound lamination of a silicon steel.

5. The machine of claim 1, wherein the coils are comprised of square or rectangular copper wire.

6. The machine of claim 1, wherein the pole pieces have a pair of axial ends, each axial end having a least a portion that protrudes through the non-metal covers.

7. The stator of claim 6, wherein a flux return is attached to one side of the stator, the flux return in contact with the protruding pole pieces, the flux return comprising a magnetically soft material.

8. The machine of claim 6, wherein the rotor is the only rotor and the stator is one of two stators, the rotor having a number of permanent magnets attached to a shaft, the two stators each having a flux return attached to one side of the stator, the respective flux return in contact with the protruding pole pieces, the flux return comprising a magnetically soft material.

9. The machine of claim 8, further comprising a heat exchanger attached to one side of the flux return.

10. The machine of claim 1, further comprising a liquid to liquid heat exchanger and a motor case, the heat exchanger attached to the motor case, the heat exchanger transferring heat from the flowable coolant within the enclosed chamber to a second flowable coolant within a second cooling means.

11. The machine of claim 1, wherein the coils are preformed of one or more rectangular copper wires, the coils of each phase formed from a continuous length of wire.

12. The machine of claim 1, wherein the pole pieces are comprised of a laminated steel, the laminated steel comprising steel laminations that are welded together with a weld pattern, wherein a percentage of the steel laminations shorted by overlapping welds ranges within approximately 15-20%.

13. The machine of claim 12, wherein a shape of each of the pole pieces is comprised of laminations that are folded in alternating fashion from a stamped or notched sheet.

14. The machine of claim 1, wherein the pole pieces are comprised of a powdered metal.

15. The machine of claim 1, wherein the pole pieces have at least one portion comprised of a laminated steel and at least one other portion comprised of a powdered metal.

16. The machine of claim 1, wherein the pole pieces are comprised of a laminated steel, the laminated steel comprising steel laminations that are formed by winding a stamped or notched sheet in a spiral fashion, the spiral wound sheets fastened to each other by an adhesive or by welds, each of the individual pole pieces cut from the spiral by laser or wire cutting.

17. The machine of claim 1, wherein the chamber is partially filled with a flowable potting compound so that solder connections are electrically insulated, and the chamber is sealed from leaking coolant.

18. The machine of claim 1, wherein the chamber comprises a plurality of diverters configured to direct a portion of the flowable coolant through a number of inter-coil spaces and enable another portion of the flowable coolant to pass along the coil to remove heat.

19. The machine of claim 18, wherein the diverters also comprise a number of bypass gaps for the flowable coolant and a number of coil interconnects.

20. The machine of claim 18, wherein the chamber comprises an inlet side and an outlet side, each chamber side further comprises a manifold with a plurality of apertures to direct the flowable coolant over and around the coils of the stator.

21.-29. (canceled)
